(19) United States
(12) Patent Application Publication
(10) Pub. No.: US 2008/0015135 A1
(43) Pub. Date: Jan. 17, 2008

(54) Compact fluid laundry detergent composition

(76) Inventors: Francesco de Buzzaccarini, Breendonk (BE); Ann De Wree, Oost-Vlaanderen (BE); Kareen Forissier, Brussels (BE); Edgar Manuel Marin-Carrillo, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/799,892

(22) Filed: May 3, 2007

Related U.S. Application Data
(60) Provisional application No. 60/798,203, filed on May 5, 2006.

(51) Int. Cl. C11D 17/08

(52) U.S. Cl. 510/336; 510/337

(57) ABSTRACT

The present invention relates to compact fluid laundry detergent composition having good economics, good cleaning and positive consumer value impression.

### CROSS REFERENCE TO RELATED APPLICATION

This application claims the benefit of U.S. Provisional Application Ser. No. 60/798,203, filed May 5, 2006.

### FIELD OF THE INVENTION

The present invention relates to compact fluid laundry detergent composition having good economics, good cleaning and positive consumer value impression.

### BACKGROUND OF THE INVENTION

Fluid laundry products, such as liquids, gels, pastes and the like are preferred by many consumers, over solid detergents. Many consumers also have a desire to conserve resources and eliminate what they perceive as waste or unnecessary, without a noticeable or significant reduction in the performance of the product. Consequently, there is renewed interest in the concentrated or so called compact laundry product. However, compaction is not as simple a solution as perceived by consumers. The reduction or increase of the components of a fluid laundry product, such as water, solvent, surfactant etc, to arrive at a concentrated or compact formula means that the relative amounts of these components is different to that present in the noncompact or dilute product.

This means to produce a compact product that has comparable performance of a noncompact or dilute product significant time and effort will be involved. For example, one way of delivering the surfactancy or cleaning desired is to use nonionic surfactants. However, while nonionic surfactants deliver comparable cleaning to surfactants like anionic surfactants, they are low foaming relative to comparable anionic surfactants. It is also well known that consumers equate the size, quantity and/or duration of the foam produced by a laundry detergent, so any predominately nonionic laundry detergent will be immediately perceived by consumers as not performing as well as a noncompact or dilute product. However, given the other laundry detergent requirements, such as needs for product stability, dispensability and the like, it is difficult to increase the amount of higher foaming surfactants such as anionic surfactants, to increase the size, quantity and/or duration of the foam produced by a laundry detergent without a corresponding trade off of another product feature, such as product stability, dispensability, cost and the like. Consequently, even though compaction of fluid laundry detergents may seem to be highly desirable it is problematic and difficult to deliver a stable, dispensable product which is having good economics, provides good cleaning and is perceived by a consumer as being good value.

Furthermore, the need for updated packaging is particularly difficult to satisfy for compact or concentrated fluid laundry detergent and other liquid consumer products since the weight of the enhanced volume of liquid product poses formidable challenges to the packaging engineer. For instance, the package must still permit convenient dispensing by consumers, who range in age from children through middle aged adults and up into the older population. Moreover, it is desirable to provide such packaging at a low cost to consumers.

Consequently, the need remains for a concentrated or compact fluid laundry detergent that is comparable in performance to existing noncompact or dilute laundry detergent. Ideally any such comparable concentrated or compact fluid laundry detergent will be presented in a fashion that is easy to use and which is aesthetically appealing to consumers.

### SUMMARY OF THE INVENTION

One aspect of the invention relates to compact fluid laundry detergent composition having good economics, good cleaning and positive consumer value impression, comprising:

(i) at least about 10%, by weight of the composition, of surfactant selected from anionic surfactants, nonionic surfactants, soap and mixtures thereof;

(ii) from about 5% to about 30%, by weight of the composition, of water, non-aminofunctional solvent and mixtures thereof;

(iii) from about 5% to about 20%, by weight of the composition, of a performance additive selected from chelants, soil suspending polymers, enzymes and mixtures thereof;

wherein the compact fluid laundry detergent composition comprises at least one of:

(A) the surfactant has a weight ratio of the anionic surfactant to the nonionic surfactant from about 1.5:1 to about 5:1, the surfactant comprises from about 5% to about 30%, by weight of the composition, of anionic surfactant and comprises from about 5% to about 40%, by weight of the composition, of the soap;

(B) from about 0.1% to about 10%, by weight of the composition, of a suds boosting agent selected from suds boosting polymers, cationic surfactants, zwitterionic surfactants, amine oxide surfactants, amphoteric surfactants, and mixtures thereof; and (C) both (A) and (B).

Another aspect of the invention relates to article of commerce for laundering, storing and dispensing liquid compositions in contact therewith, comprising:

(a) a compact fluid laundry detergent composition having good economics, good cleaning and positive consumer value impression, comprising:

(i) at least about 10%, by weight of the composition, of surfactant selected from anionic surfactants, nonionic surfactants, soap and mixtures thereof;

(ii) from about 0.001% to about 3% by weight of the composition, of perfume;

(iii) from about 1% to about 30%, by weight of the composition, of water;

(iv) from about 1% to about 15%, by weight of the composition, of non-aminofunctional solvent; and

(v) from about 5% to about 20%, by weight of the composition, of a performance additive selected from chelants, soil suspending polymers, enzymes and mixtures thereof;

wherein the compact fluid laundry detergent composition comprises at least one of:

(A) the surfactant has a weight ratio of the anionic surfactant to the nonionic surfactant from about 1.5:1 to about 5:1, the surfactant comprises from about 15% to about 40%, by weight of the composition, of anionic surfactant and comprises from about 5% to about 40%, by weight of the composition, of the soap;

(B) from about 0.1% to about 10%, by weight of the composition, of a suds boosting agent selected from suds boosting polymers, cationic surfactants, zwitterionic surfactants, amine oxide surfactants, amphoteric surfactants, and mixtures thereof; and

(C) both (A) and (B).

(b) a water insoluble container in direct contact with and releasably storing the compact fluid laundry detergent composition;

Another aspect of the invention relates to compact fluid laundry detergent composition having good economics, good cleaning and positive consumer value impression, comprising:

(i) from about 20% to about 80%, by weight of the composition, of surfactant selected from anionic surfactants, nonionic surfactants, soap and mixtures thereof;

(ii) from about 0.001% to about 3%, by weight of the composition, perfume;

(iii) from about 5% to about 30%, by weight of the composition, water;

(iv) from about 3% to about 10%, by weight of the composition, of non-aminofunctional solvent;

(v) from about 10% to about 20%, by weight of the composition, soap; and

(vi) from about 0% to about 1%, by weight of the composition, of hydrotropes and/or externally structuring thickeners;

(vii) from about 0% to about 5%, by weight of the composition, of amine oxide and/or betaine;

(viii) from about 5% to about 20%, by weight of the composition, of a performance additive selected from chelants, soil suspending polymers, enzymes and mixtures thereof;

wherein the compact fluid laundry detergent composition comprises at least one of:

(A) the surfactant has a weight ratio of the anionic surfactant to the nonionic surfactant from about 1.5:1 to about 5:1, the surfactant comprises from about 15% to about 40%, by weight of the composition, of anionic surfactant and comprises from about 10% to about 20%, by weight of the composition, of the soap;

(B) from about 0.1% to about 10%, by weight of the composition, of a suds boosting agent selected from suds boosting polymers, cationic surfactants, zwitterionic surfactants, amine oxide surfactants, amphoteric surfactants, and mixtures thereof; and

(C) both (A) and (B).

### BRIEF DESCRIPTION OF THE DRAWINGS

In the accompanying drawings:

FIG. 1 is an illustrative example of a front view of one possible water insoluble container.

FIG. 2 is a section of the water insoluble container of FIG. 1.

FIG. 3 is an illustrative example of a front view of another possible water insoluble container.

FIG. 4 an exploded view of the water insoluble container of FIG. 3.

FIG. 5 is a section of the water insoluble container of FIG. 3 showing the valve in the closed position.

FIG. 6 is a section of the valve of the water insoluble container of FIG. 3.

FIG. 7 is a section of the water insoluble container of FIG. 3 showing the valve in the open position.

FIG. 8 is an illustrative example of the water insoluble container illustrated in FIG. 3 being gripped by a human hand.

FIG. 9 is an illustrative example of another water insoluble container.

FIG. 10 is an illustrative example of yet another water insoluble container.

### DETAILED DESCRIPTION OF THE INVENTION

Definitions—As used herein, “compact fluid laundry detergent composition” refers to any laundry treatment composition comprising a fluid capable of wetting and cleaning fabric e.g., clothing, in a domestic washing machine. The composition can include solids or gases in suitably subdivided form, but the overall composition excludes product forms which are nonfluid overall, such as tablets or granules. Compositions which are overall gases are also excluded. The compact fluid detergent compositions have densities in the range from about 0.9 to about 1.3 grams per cubic centimeter, more specifically from about 1.00 to about 1.10 grams per cubic centimeter, excluding any solid additives but including any bubbles, if present.

Examples of compact fluid laundry detergent compositions include heavy-duty liquid laundry detergents for use in the wash cycle of automatic washing-machines, liquid finewash and liquid color care detergents such as those suitable for washing delicate garments, e.g., those made of silk or wool, either by hand or in the wash cycle of automatic washing-machines. The corresponding compositions having flowable yet stiffer consistency, known as gels or pastes, are likewise encompassed. The rheology of shear-thinning gels is described in more detail in the literature, see for example WO04027010A1 Unilever.

In general the compact fluid laundry detergent compositions herein may be isotropic or non-isotropic, however, for some embodiments, they do not generally split into separate layers such as phase split detergents described in the art. One specific illustrative composition is non-isotropic and on storage said composition is either (i) free from splitting into two layers or, (ii) if said composition splits into layers, a single major layer is present and said major layer comprises at least about 80% by weight, more specifically more than about 90%, even more specifically more than about 95% of the composition. Other illustrative compositions are isotropic.

As used herein, when a composition and/or method is “substantially free” of a specific ingredient(s) it is meant that specifically none, or in any event no functionally useful amount, of the specific ingredient(s) is purposefully added to the composition. It is understood to one of ordinary skill in the art that trace amounts of various ingredient(s) may be present as impurities. For avoidance of doubt otherwise, “substantially free” shall be taken to mean that the composition contains less than about 0.1%, specifically less than 0.01%, by weight of the composition of an indicated ingredient.

(i) Surfactant—The compositions and methods of the invention comprise one or more surface active agents (surfactants), more specifically the surfactant is selected from at least partially water soluble, specifically fully water soluble surfactants having a “detersive” or cleaning effect attributable to interfacial tension reduction at interfaces.

Suitable surfactants are selected from the common commercially available anionic surfactants, nonionic surfactants, cationic surfactants, amphoteric surfactants, zwitterionic surfactants, soap and/or fatty acids and/or mixtures thereof.

The surfactant comprises at least about 10%, specifically from more than 20% to about 80%, more specifically from about 20% to about 70%, even more specifically from about 40% to about 60%, by weight of the fluid laundry detergent compositions.

In one embodiment, the surfactants are substantially linear.

In another embodiment, the compact fluid laundry detergent composition is internally structured by a surfactant, and the fluid laundry detergent has the physical form of a flowable liquid, gel or paste.

In one embodiment, the surfactant comprises less than about 5%, even more specifically from about 0% to less than about 5%, by weight of the composition, even more specifically still substantially free of amine oxide and/or amphoteric surfactant, such as C8-C18 betaine.

Illustrative examples of surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, in U.S. Pat. No. 4,239,659, Murphy, issued Dec. 16, 1980, U.S. Pat. No. 4,285,841, Barrat et al, issued Aug. 25, 1981, U.S. Pat. No. 4,284,532, Leikhim et al, issued Aug. 18, 1981, U.S. Pat. No. 4,285,841, U.S. Pat. No. 3,919,678 and in U.S. Pat. Nos. 2,220,099 and 2,477,383. Surfactants generally are well known, being described in more detail in Kirk Othmer's Encyclopedia of Chemical Technology, 3rd Ed., Vol. 22, pp. 360-379, “Surfactants and Detersive Systems”, McCutcheon's, Detergents & Emulsifiers, by M.C. Publishing Co., (North American edition 1997), Schwartz, et al., Surface Active Agents, Their Chemistry and Technology, New York: Interscience Publishers, 1949; and further information and examples are given in “Surface Active Agents and Detergents” (Vol. I and II by Schwartz, Perry and Berch). See also Surfactant Science Series, Volumes 67 and 129, published by Marcel Dekker, NY, pertaining to liquid detergents and therein especially the chapters pertaining to heavy-duty liquid laundry detergents.

Nonionic Surfactant—The compositions and methods of the present invention contain a nonionic surfactant as the essential surfactant when no other surfactant is present, or a mixture of surfactants wherein a nonionic surfactant is an optional component. Mixtures of two or more surfactants, including two or more nonionic surfactants, can be used.

Illustrative examples of suitable nonionic surfactants include: alcohol ethoxylates (e.g. Neodol 25-9 from Shell Chemical Co.), alkyl phenol ethoxylates (e.g. Tergitol NP-9 from Union Carbide Corp.), alkylpolyglucosides (e.g. Glucapon 600CS from Henkel Corp.), polyoxyethylenated polyoxypropylene glycols (e.g. Pluronic L-65 from BASF Corp.), sorbitol esters (e.g. Emsorb 2515 from Henkel Corp.), polyoxyethylenated sorbitol esters (e.g. Emsorb 6900 from Henkel Corp.), alkanolamides (e.g. Alkamide DC212/SE from Rhone-Poulenc Co.), and N-alkypyrrolidones (e.g. Surfadone LP-100 from ISP Technologies Inc.); and combinations thereof. Additional, illustrative suitable nonionic surfactants are those disclosed in U.S. Pat. Nos. 4,316,812 and 3,630,929.

Nonionic surfactant, when present in the composition may be present in the amount of from about 0.01% to about 70%, more specifically from about 1% to about 40%, even more specifically from about 5% to about 20%, by weight of the composition.

Anionic Surfactants—As used herein, the term “anionic surfactant” refers to an anionic surfactant other than soap. The compositions and methods of the present invention may contain an anionic surfactant. Mixtures of two or more surfactants, including two or more anionic surfactants, or mixtures thereof with, for example, nonionic surfactants can be used. Preferred anionic surfactants include LAS, AES (sometimes termed SLES), MES and mixtures thereof.

For formula accounting purposes, it is useful to note that LAS is normally formulated into the compositions in acid, i.e., HLAS, form, and is thereafter neutralized or at least partially neutralized in-situ so as to form NaLAS, KLAS, alkanolammonium LAS and the like. Other common anionic surfactants are typically formulated in pre-neutralized form.

Illustrative examples of suitable anionic surfactants includes: linear alkyl benzene sulfonates (e.g. Vista C-500 from Vista Chemical Co.), branched linear alkyl benzene sulfonates (e.g. MLAS), alkyl sulfates (e.g. Polystep B-5 from Stepan Co.), branched alky sulfates, alkyl alkoxysulfates (e.g. Standapol ES-3 from Stepan Co.), alpha olefin sulfonates (e.g. Witconate AOS from Witco Corp.), alpha sulfo methyl esters (e.g. Alpha-Step MCp-48 from Stepan Co.) and isethionates (e.g. Jordapon Cl from PPG Industries Inc.), and combinations thereof.

The anionic surfactants may have any suitable cation as counterion. Mixtures of cations are also possible. Illustrative examples of suitable cations for the anionic surfactants include, sodium, potassium, ammonium, substituted ammonium, amino functional cations, such as alkanolammonium and the like, and the like and mixtures thereof. In one embodiment, the surfactant is free of non-alkanolfunctionalised monoammonium and diammonium cations.

In one embodiment, a portion of the anionic surfactants present in the composition and methods of the present invention may be neutralized in situ, i.e. during the preparation of the compact fluid laundry detergent composition a portion of the anionic surfactant is added in its acid or non neutralized form, for example, the acid or non neutralized form of alkyl benzene sulfonate is alkyl benzenesulfonic acid, and then non neutralized anionic surfactant is either neutralized with a neutralizer, such as NaOH, Monoethanolamine, diethanoamine and the like, already present in the composition, or one that has been added subsequent to the addition of the non neutralized anionic surfactant. In another embodiment, the non neutralized anionic surfactant is either neutralized with a neutralizer immediately prior to addition to the composition. Additional information on suitable neutralizers may be found herein.

Anionic surfactant, when present in the composition may be present in the amount of from about 0.01,% to about 70%, more specifically from about 10% to about 50%, even more specifically from about 20% to about 40% by weight of the detergent composition.

Soap—Soap as defined herein includes fatty acids and soluble salts thereof. Fatty acids and/or soaps or their derivatives are known to possess multiple functionalities in detergents, acting as surfactants, builders, thickeners, foam suppressors etc. Therefore, for avoidance of doubt, for formula accounting purposes and in preferred embodiments herein, soaps and fatty acids are listed separately. Moreover, soaps are commonly neutralized or partially neutralized in-situ in the formulation using neutralizers such as sodium hydroxide, potassium hydroxide and/or alkanolamines such as MEA.

Any soluble soap or fatty acid is suitable for use herein, including, lauric, myristic, palmitic stearic, oleic, linoleic, linolenic acid, and mixtures thereof. Naturally obtainable fatty acids, which are usually complex mixtures, are also suitable (such as tallow, coconut, and palm kernel fatty acids). In one embodiment, from about 10% to about 25%, by weight of the composition, of fatty acid may be present in the composition.

In one embodiment, the soap has a degree of neutralization of greater than about 50%. In another embodiment, the surfactant comprises from about 0% to less than about 40%, by weight of the composition, of soap.

Ratio of Anionic Surfactant to Nonionic Surfactant—In one embodiment, of compositions and methods of the present invention, the weight ratio of the anionic surfactant to the nonionic surfactant from about 1.5:1 to about 5:1, more specifically greater than about 2:1 to about 5:1, the surfactant comprises from about 15% to about 40%, more specifically from about 15% to about 30%, even more specifically from about 20% to about 30%, by weight of the composition, of anionic surfactant and comprises from about 5% to about 40%, more specifically from about 10% to about 30%, by weight of the composition, of the soap.

(ii) Water—The compact detergent compositions according to the present invention also contain water. The amount of the water present in the compositions herein will be relatively small, relative to traditional fluid laundry detergent compositions, suitably from about 1 wt % to about 30 wt %, specifically from about 10% to about 25%, by weight of the cleaning composition.

In one embodiment, the water to be used is selected from distilled, deionized, filtered, reverse osmosis treated, and combinations thereof. In another optional embodiment, of the water may be any potable water, e.g., as received from a city water treatment works.

(iii) Non-Aminofunctional Solvent—As used herein, “non-aminofunctional solvent” refers to any solvent which contains no amino functional groups. Non-aminofunctional solvent include, for example: C₁-C₈ alkanols such as methanol, ethanol and/or propanol and/or 1-ethoxypentanol; C₂-C₆ diols; C₃-C₈ alkylene glycols; C₃-C₈ alkylene glycol mono lower alkyl ethers; glycol dialkyl ether; lower molecular weight polyethylene glycols; C₃-C₉ triols such as glycerol; and mixtures thereof. More specifically non-aminofunctional solvent are liquids at ambient temperature and pressure (i.e. 21° C. and 1 atmosphere), and comprise carbon, hydrogen and oxygen. When present, non-aminofunctional solvent may comprise from about 0% to about 25%, more specifically from about 1 to about 20%, even more specifically from about 5% to about 15% by weight of the compositions herein.

In one embodiment, the sum of water and non-aminofunctional solvent, by weight of the composition, is from 5% to 45%, specifically 10% to 30% by weight of the composition specifically no more than about 40%, more specifically no more than 35%, more specifically still no more than 30%, even more specifically still no more than 25%, by weight of the composition, and specifically having from about 0% to about 25%, more specifically from about 1% to about 20%, more specifically still from about 5% to about 15%, by weight of the composition, of the non-aminofunctional solvent.

Suds Boosting Agent—In one embodiment, of compositions and methods of the present invention, comprise from about 0.1% to about 10%, more specifically from about 0.5% to about 5%, by weight of the composition, of a suds boosting agent selected from suds boosting polymers, cationic surfactants, zwitterionic surfactants, amine oxide surfactants, amphoteric surfactants, and mixtures thereof.

In another embodiment, the compositions and methods of the present invention are substantially free of suds boosting agent.

Suds Boosting Polymers—In one embodiment, the suds boosting agent may comprise a suds boosting polymer. In one embodiment, these suds boosting polymers may be selected from polymeric suds stabilizers, block polymeric suds stabilizer, zwitterionic polymeric suds stabilizers, cationic polymeric suds stabilizers, anionic polymeric suds stabilizers and mixtures thereof. In one embodiment, the polymeric suds stabilizers may be selected from dialkyl acrylamides, zwitterionic polymeric suds stabilizers, cationic polymeric suds stabilizers, anionic polymeric suds stabilizers and mixtures thereof.
Acrylamide Polymers—One class of polymeric suds stabilizer according to the present invention are the dialkyl acrylamides having the formula: 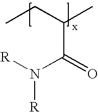
wherein each R is independently hydrogen, C₁-C₆ alkyl, and mixtures thereof. The index x has the value from about 50 to about 1,500; preferably the index x has a value such that the resulting polymeric suds stabilizer has an average molecular weight of from about 2,500 to about 150,000 daltons. An example of a preferred dialkyl acrylamide is dimethyl acrylamide (DMA) homopolymer having the formula: 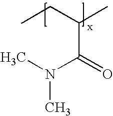
wherein x has a value such that the molecular weight is from about 2,500 to about 150,00 daltons.
Methacrylate Ester Polymers—Another class of polymeric suds stabilizer according to the present invention are the (N,N-dialkylamino)alkyl methacrylates having the formula: 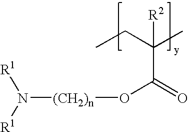
wherein each R¹ is independently hydrogen, C₁-C₈ alkyl, and mixtures thereof. R² is hydrogen, C₁-C₆ alkyl, and mixtures thereof. The index n is from 2 to about 6. The index y is from about 30 to about 1,000; preferably the index y has a value such that the resulting polymeric suds stabilizer has an average molecular weight of from about 2,500 to about 150,000 daltons. An example of a preferred (N,N-dialkylamino)alkyl methacrylate is 2-dimethylaminoethyl methacrylate (DMAM) homopolymer having the formula: 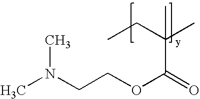
wherein y has a value such that the molecular weight is from about 2,500 to about 150,00 daltons.
Zwitterionic polymer—One class of zwitterionic polymer suitable for use as polymeric suds stabilizer has the formula: 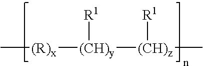
wherein R is C₁-C₁₂ linear alkylene, C₁-C₁₂ branched alkylene, and mixtures thereof. R¹ and R² are defined herein after. The index x is from 0 to 6; y is 0 or 1; z is 0 or 1.

The index n has the value such that the zwitterionic polymers have an average molecular weight of from about 1,000 to about 2,000,000 daltons. The molecular weight of the polymeric suds boosters, can be determined via conventional gel permeation chromatography.

Anionic Units —R¹ is a unit capable of having a negative charge at a pH of from about 4 to about 12. Preferred R¹ has the formula:
-(L)ᵢ-(S)ⱼ—R³
wherein L is a linking unit independently selected from the following: 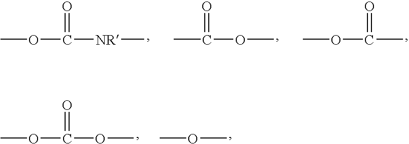
mixtures thereof, wherein R′ is independently hydrogen, C₁-C₄ alkyl, and mixtures thereof; or alternatively R′ and S can form a heterocycle of 4 to 7 carbon atoms. The index is from 0 to about 20. When the index i is 0, L is absent.

For anionic units S is a “spacing unit” wherein each S unit is independently selected from C₁-C₁₂ linear alkylene, C₁-C₁₂ branched alkylene, C₃-C₁₂ linear alkenylene, C₃-C₁₂ branched alkenylene, C₃-C₁₂ hydroxyalkylene, C₄-C₁₂ dihydroxyalkylene, C₆-C₁₀ arylene, C₈-C₁₂ dialkylarylene, —(R⁵⁰)ₖR⁵—, —(R⁵⁰)ₖR⁶(OR⁵)ₖ—, —CH₂CH(OR⁷)CH₂—, and mixtures thereof; wherein R⁵ is C₂-C₄ linear alkylene, C₃-C₄ branched alkylene, and mixtures thereof. The index j is from 0 to about 20. When the index j is O, S is absent. The index k is from 1 to about 20.

R³ is independently selected from hydrogen, —CO₂M, —SO₃M, —OSO₃M, —CH₂P(O)(OM)₂, —OP(O)(OM)₂, units having the formula:
—CR⁸R⁹R¹⁰
wherein each R⁸, R⁹, and R¹⁰ is independently selected from the group consisting of hydrogen, —(CH₂)ₘR¹¹, and mixtures thereof, wherein R¹¹ is —CO₂H, —SO₃M, —OSO₃M, —CH(CO₂H)CH₂CO₂H, —CH₂P(O)(OH)₂, —OP(O)(OH)₂, and mixtures thereof. M is hydrogen or a salt forming cation, preferably hydrogen. The index m has the value from 0 to 10.
Cationic Units—R² is a unit capable of having a positive charge at a pH of from about 4 to about 12. Preferred R² has the formula:
-(L¹)_{i′}-(S)_{j′}—R⁴
wherein L¹ is a linking unit independently selected from the following: 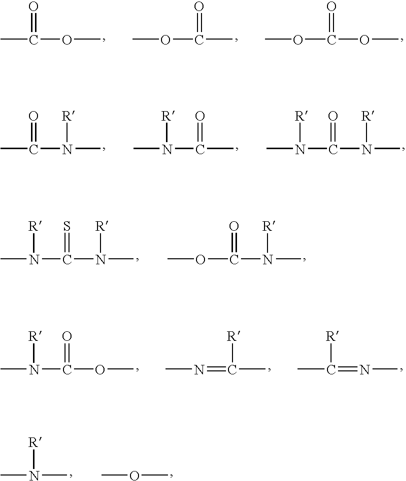
and mixtures thereof; wherein R′ is independently hydrogen, C₁-C₄ alkyl, and mixtures thereof; or alternatively R′ and S can form a heterocycle of 4 to 7 carbon atoms. The index i′ is from 0 to about 20. When the index i′ is 0, L¹ is absent.

For cationic units S is as herein described. The index j′ is from 1 to about 20. When the index j′ is O, S is absent

R⁴ is independently selected from amino, alkylamino, carboxamide, 3-imidazolyl, 4-imidazolyl, 2-imidazolinyl, 4-imidazolinyl, 2-piperidinyl, 3-piperidinyl, 4-piperidinyl, 1-pyrazolyl, 3-pyrazoyl, 4-pyrazoyl, 5-pyrazoyl, 1-pyrazolinyl, 3-pyrazolinyl, 4-pyrazolinyl, 5-pyrazolinyl, 2-pyridinyl, 3-pyridinyl, 4-pyridinyl, piperazinyl, 2-pyrrolidinyl, 3-pyrrolidinyl, guanidino, amidino, and mixtures thereof.

An example of one zwitterionic polymer has the formula: 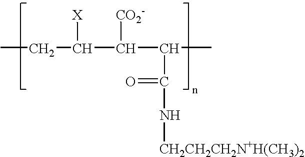
wherein X is C₆, n has a value such that the average molecular weight is from about 5,000 to about 1,000,000 daltons.

Further zwitterionic polymers are polymers comprising monomers wherein each monomer has only cationic units or anionic units, said polymers have the formula: 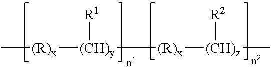
wherein R, R¹, x, y, and z are the same as defined herein above; n₁+n²=n such that n has a value wherein the resulting zwitterionic polymer has a molecular weight of form about 5,000 to about 1,000,000 daltons.

An example of a polymer having monomers with only an anionic unit or a cationic unit has the formula: 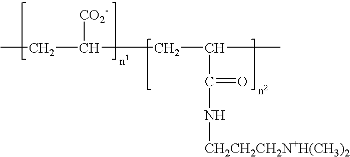
wherein the sum of n¹ and n² provide a polymer with an average molecular weight of from about 5,000 to about 750,000 daltons.

Another zwitterionic polymer are polymers which have limited crosslinking, said polymers having the formula:

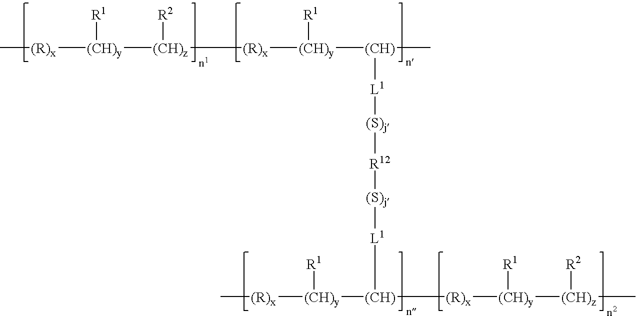

wherein R, R¹, L¹, S, j′, x, y, and z are the same as defined herein above; n′ is equal to n″, and the value n′+n″ is less than or equal to 5% of the value of n¹+n²=n; n provides a polymer with an average molecular weight of from about 1,000 to about 2,000,000 daltons. R¹² is nitrogen, C₁-C₁₂ linear alkylene amino alkylene having the formula:
—R¹³—N—R¹³
L¹, and mixtures thereof, wherein each R¹³ is independently L¹ or ethylene.

Additional information on suds boosting polymers, polymeric suds stabilizers, block polymeric suds stabilizer, zwitterionic polymeric suds stabilizers, dialkyl acrylamides, cationic polymeric suds stabilizers and anionic polymeric suds stabilizers can be found in U.S. Pat. Nos. 6,827,795, 6,277,811, 6,369,012, 6,372,708, 6,528,476, 6,528,477, 6,573,234, 6,825,157, 6,645,925, and 6,903,064.

Cationic surfactants—Many cationic surfactants are known in the art, and almost any cationic surfactant having at least one long chain alkyl group of about 10 to 24 carbon atoms is suitable in the present invention. Such compounds are described in “Cationic Surfactants”, Jungermann, 1970, incorporated by reference.

Specific cationic surfactants which can be used as surfactants in the subject invention are described in detail in U.S. Pat. No. 4,497,718.

Zwitterionic surfactants—Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. The cationic atom in the quaternary compound can be part of a heterocyclic ring. In all of these compounds there is at least one aliphatic group, straight chain or branched, containing from about 3 to 18 carbon atoms and at least one aliphatic substituent containing an anionic water solubilizing group, e.g., carboxy, sulfonate, sulfate, phosphate, or phosphonate.

Specific examples of zwitterionic surfactants which may be used are set forth in U.S. Pat. No. 4,062,647.

Amine Oxide surfactants—The suds boosting agent may comprise amine oxide. One specific amine oxide which is suitable for use as a suds boosting agent has the general formula I:
R¹(EO)ₓ(PO)_{y}(BO)_{z}N(O)(CH₂R′)₂.qH₂O (I).

In general, it can be seen that the structure (I) provides one long-chain moiety R¹(EO)ₓ(PO)_{y}(BO)_{z} and two short chain moieties, CH₂R′. R′ is preferably selected from hydrogen, methyl and —CH₂OH. In general R¹ is a primary or branched hydrocarbyl moiety which can be saturated or unsaturated, preferably, R¹ is a primary alkyl moiety. When x+y+z=0, R¹ is a hydrocarbyl moiety having chainlength of from about 8 to about 18. When x+y+z is different from 0, R¹ may be somewhat longer, having a chainlength in the range C₁₂-C₂₄. The general formula also encompasses amine oxides wherein x+y+z=0, R₁═C₈-C₁₈, R′=H and q=0-2, preferably 2. These amine oxides are illustrated by C₁₂₋₁₄ alkyldimethyl amine oxide, tetradecyldimethyl amine oxide, hexadecyl dimethylamine oxide, octadecylamine oxide and their hydrates, especially the dihydrates as disclosed in U.S. Pat. Nos. 5,075,501 and 5,071,594.

Other specific suitable amine oxides include those wherein x+y+z is different from zero, more specifically x+y+z is from about 1 to about 10, R¹ is a primary alkyl group containing about 8 to about 24 carbons, more specifically from about 12 to about 16 carbon atoms; in these embodiments y+z is specifically 0 and x is specifically from about 1 to about 6, more specifically from about 2 to about 4; EO represents ethyleneoxy; PO represents propyleneoxy; and BO represents butyleneoxy. Such amine oxides can be prepared by conventional synthetic methods, e.g., by the reaction of alkylethoxysulfates with dimethylamine followed by oxidation of the ethoxylated amine with hydrogen peroxide.

Some more specific amine oxides suitable for use as a suds boosting agent are solutions at ambient temperature. Illustrative examples of commercially available amine oxides include those made by Akzo Chemie, Ethyl Corp., and Procter & Gamble. Additional information on amine oxide surfactants may be found in Kirk Othmer's Encyclopedia of Chemical Technology, 3rd Ed., Vol. 22, pp. 360-379, “Surfactants and Detersive Systems”,

Whereas in certain of the embodiments R′ is H, there is some latitude with respect to having R′ slightly larger than H. More specifically, wherein R′ is CH₂OH, such as hexadecylbis(2-hydroxyethyl)amine oxide, tallowbis(2-hydroxyethyl)amine oxide, stearylbis(2-hydroxyethyl)amine oxide and oleylbis(2-hydroxyethyl)amine oxide, dodecyldimethylamine oxide dihydrate.

In another embodiment, of this aspect of the present invention the compositions may contain amine oxides with linear or branched alkyl chain lengths of about 10- to about 22, more specifically about 14 about 18. In another embodiment, of this aspect of the present invention the amine oxides may be branched amine oxides with an of average carbon count 16/17, for example the branched alkyl chain could be isostearyl.

Amphoteric surfactants—Amphoteric synthetic detergents can be broadly described as derivatives of aliphatic or aliphatic derivatives of heterocyclic secondary and tertiary amines in which the aliphatic radical may be a straight chain or a branched and wherein one of the aliphatic substituents contains from about 8 to 18 carbon atoms and at least one contains an anionic water-solubilizing group, e.g. carboxy, sulfonate, sulfate. Examples of compounds falling within this definition are sodium 3(dodecylamino)propionate, sodium 3-(dodecylamino)propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis(2-hydroxyethyl)-2-sulfato-3-dodecoxypropylamine.

Performance Additive—The compact detergent composition and methods herein comprise from about 5% to about 20%, by weight of the composition, of a performance additive selected from chelants, soil suspending polymers, enzymes and mixtures thereof.

Soil Suspending Polymers—In one embodiment, the performance additive may comprise one or more soil suspending polymers. In one embodiment, the compositions herein may comprise from about 1% to about 15%, more specifically 2% to 10%, more specifically 4% to 28% by weight of the composition of a soil suspending polymer. In one embodiment, the soil suspending polymer may be selected from polyesters, polycarboxylates, saccharide-based materials, modified polyethyleneimines, modified hexamethylenediamine, branched polyaminoamines, modified polyaminoamide, hydrophobic polyamine ethoxylate polymers, polyamino acids, polyvinylpyridine N-oxide, N-vinylimidazole N-vinylpyrrolidone copolymers, polyvinylpyrrolidone, polyvinyloxazolidone, polyvinylimidazole and mixtures thereof. The degree of polymerization for these materials, which is most easily expressed in terms of weight average molecular weight, is not critical provided the material has the desired water solubility and soil-suspending power. Suitable polymers will also, generally, have a water solubility of greater than 0.3% at normal usage temperatures.

Polyesters—Polyesters of terephthalic and other aromatic dicarboxylic acids having soil release properties such as polyethylene terephthalate/polyoxyethylene terephthalate and polyethylene terephthalate/polyethylene glycol polymers, among other polyester polymers, may be utilized as the soil suspending polymer in the present composition.

Suitable polyesters include polyesters formed from: (1) ethylene glycol, 1,2-propylene glycol or a mixture thereof; (2) a polyethylene glycol (PEG) capped at one end with a C₁-C₄ alkyl group; (3) a dicarboxylic acid (or its diester); and optionally (4) an alkali metal salt of a sulfonated aromatic dicarboxylic acid (or its diester), or if branched polyesters are desired, a polycarboxylic acid (or its ester). The block polyester polymers are further discussed in U.S. Pat. No. 4,702,857. Poly(vinyl ester) hydrophobe segments, including graft copolymers of poly(vinyl ester), e.g., C₁-C₆ vinyl esters, preferably poly(vinyl acetate), grafted onto polyalkylene oxide backbones, commercially available under the tradenames of SOKALAN®, such as SOKALAN® HP-22, available from BASF, Germany may also be utilized.

Additional information and illustrative examples of polyesters may be found in U.S. Pat. No. 3,962,152, U.S. Pat. No. 3,959,230, U.S. Pat. No. 3,959,230 U.S. Pat. No. 3,893,929, U.S. Pat. No. 4,968,451, U.S. Pat. No. 4,711,730, U.S. Pat. No. 4,702,857, U.S. Pat. No. 4,721,580, U.S. Pat. No. 4,877,896, U.S. Pat. No. 5,415,807, U.S. Pat. No. 4,427,557, U.S. Pat. No. 4,201,824 and EP 0752468 B1.

Polycarboxylates—The present composition may comprise a polycarboxylate polymer or co-polymer comprising a carboxylic acid monomer. A water soluble carboxylic acid polymer can be prepared by polyimerizing a carboxylic acid monomer or copolymerizing two monomers, such as an unsaturated hydrophilic monomer and a hydrophilic oxyalkylated monomer. Examples of unsaturated hydrophilic monomers include acrylic acid, maleic acid, maleic anhydride, methacrylic acid, methacrylate esters and substituted methacrylate esters, vinyl acetate, vinyl alcohol, methylvinyl ether, crotonic acid, itaconic acid, vinyl acetic acid, and vinylsulphonate.

Additional information and illustrative examples of polycarboxylates may be found in U.S. Pat. No. 5,162,475, U.S. Pat. No. 4,622,378, U.S. Pat. No. 5,536,440, U.S. Pat. No. 5,574,004, U.S. Pat. No. 5,147,576, U.S. Pat. No. 5,073,285, U.S. Pat. No. 5,534,183, and WO 03/054044.

Saccharide based materials—The present composition may comprise a soil suspension polymer derived from saccharide based materials. Saccharide based materials may be natural or synthetic and include derivatives and modified saccharides. Suitable saccharide based materials include cellulose, gums, arabinans, galactans, seeds and mixtures thereof. Saccharide derivatives may include saccharides modified with amines, amides, amino acids, esters, ethers, urethanes, alcohols, carboxylic acids, silicones, sulphonates, sulphates, nitrates, phosphates and mixtures thereof.

Modified celluloses and cellulose derivatives, such as carboxymethylcellulose, hydroxyethylcellulose, methyl cellulose, ethyl cellulose, cellulose sulphate, cellulose acetate (see U.S. Pat. No. 4,235,735), sulphoethyl cellulose, cyanoethyl cellulose, ethyl hydroxyethylcellulose, hydroxyethyl cellulose and hydroxypropylcellulose are suitable for use in the composition. Some modified celluloses are discussed in GB 1 534 641, U.S. Pat. No. 6,579,840 B1, WO 03/040279 and WO 03/01268.

Another example of a soil suspending polymer suitable for use in the present invention includes saccharide derivatives that are polyol compounds comprising at least three hydroxy moieties, preferably more than three hydroxy moieties, most preferably six or more hydroxy moieties.

Suitable polyol compounds for use in the present invention include maltitol, sucrose, xylitol, glycerol, pentaerythitol, glucose, maltose, matotriose, maltodextrin, maltopentose, maltohexose, isomaltulose, sorbitol, poly vinyl alcohol, partially hydrolyzed polyvinylacetate, xylan reduced maltotriose, reduced maltodextrins, polyethylene glycol, polypropylene glycol, polyglycerol, diglycerol ether and mixtures thereof.

Modified Polyethyleneimine PolyMer—The present composition may comprise a modified polyethyleneimine polymer. The modified polyethyleneimine polymer has a polyethyleneimine backbone having a molecular weight from about 300 to about 10000 weight average molecular weight, preferably from about 400 to about 7500 weight average molecular weight, preferably about 500 to about 1900 weight average molecular weight and preferably from about 3000 to 6000 weight average molecular weight.

For example, but not limited to, below is shown possible modifications to terminal nitrogen atoms in the polyethyleneimine backbone where R represents an ethylene spacer and E represents a C₁-C₄ alkyl moiety and X⁻ represents a suitable water soluble counterion.

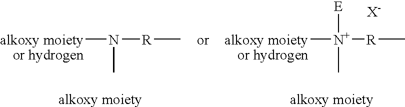

Also, for example, but not limited to, below is shown possible modifications to internal nitrogen atoms in the polyethyleneimine backbone where R represents an ethylene spacer and E represents a C₁-C₄ alkyl moiety and X— represents a suitable water soluble counterion. 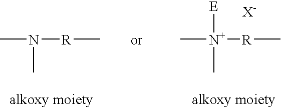
Modified Hexamethylenediamine—The present composition may comprise a modified hexamentylenediamine. The modification of the hexamentylenediamine includes: (1) one or two alkoxylation modifications per nitrogen atom of the hexamentylenediamine. The alkoxylation modification consisting of the replacement of a hydrogen atom on the nitrogen of the hexamentylenediameine by a (poly)alkoxylene chain having an average of about 1 to about 40 alkoxy moieties per modification, wherein the terminal alkoxy moiety of the alkoxylene chain is capped with hydrogen, a C1-C4 alkyl, sulfates, carbonates, or mixtures thereof; (2) a substitution of one C1-C4 alkyl moiety and one or two alkoxylation modifications per nitrogen atom of the hexamentylenediamine. The alkoxylation modification consisting of the replacement of a hydrogen atom by a (poly)alkoxylene chain having an average of about 1 to about 40 alkoxy moieties per modification wherein the terminal alkoxy moiety of the alkoxylene chain is capped with hydrogen, a C1-C4 alkyl or mixtures thereof; or (3) a combination thereof. The alkoxylation may be in the form of ethoxy, propoxy, butoxy or a mixture thereof. U.S. Pat. No. 4,597,898 Vander Meer, issued Jul. 1, 1986,

A preferred modified hexamethylenediamine has the general structure below: 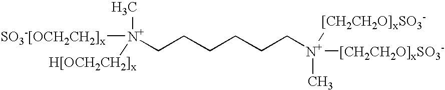
wherein x is from about 20 to about 30 and approximately 40% of the (poly)alkoxylene chain terminal alkoxy moieties are sulfonated.

A illustrative modified hexamethylenediamine has the general structure below: 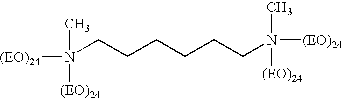
available under the tradename LUTENSIT® from BASF and such as those described in WO 01/05874.
Branched Polyaminoamines—An embodiment, of a soil suspending polymer is exemplified in structural formula below: 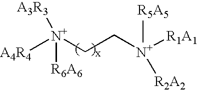
where x of the polyaminoamine can be from 1 to 12. R₅ and R₆ of the polyaminoamine may not be present (at which case N is neutral), and/or may be independently chosen from group of H, aliphatic C₁-C₆, alkylene C₂-C₆, arylene, or alkylarylene. R₁, R₂, R₃, and R₄ of the polyaminoamine are independently chosen from the group of H, OH, aliphatic C₁-C₆, alkylene C₂-C₆, arylene, or alkylarylene, and mixtures of thereof. A₁, A₂, A₃, A4, A₅, and A₆_{_{—}} of the polyaminoamine are capping groups independently selected from hydrogen, hydroxy, sulfate, sulfonate, carboxylate, phosphate, and mixtures thereof. If R₁, R₂, R₃, or R₄ are N(CH₂)ₓCH₂, than it represent continuation of this structure by branching. See also U.S. Pat. No. 4,597,898; U.S. Pat. No. 4,891,160; U.S. Pat. No. 5,565,145; and U.S. Pat. No. 6,075,000. The average degree of alkoxylation can also be more than 7, preferably from about 7 to about 40.
Modified Polyaminoamide—Modified polyaminoamides, such as the ones discussed in US 2005/0209125 A1, may be utilized as a soil suspending polymer. Suitable modified polyaminoamides have, depending on their degree of alkoxylation, a number average molecular weight (Mₙ) of from 1,000 to 1,000,000.

One embodiment, of a modified polyaminoamide has the formula: 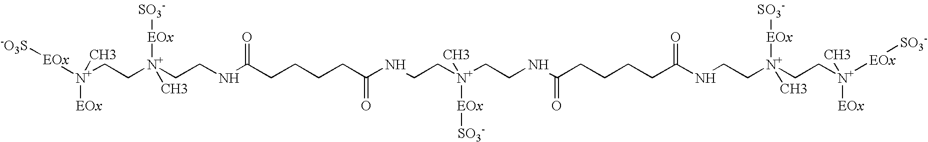
wherein x of the polyaminoamide is from 10 to 200. EO in the polyaminoamide represents ethoxy moieties.
Hydrophobic polyamine ethoxylate polymers—Soil suspending polymer for the composition may include hydrophobic polyamine ethoxylate polymers characterized by comprising a general formula: 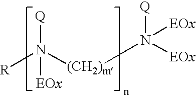
R of the hydrophobic polyamine ethoxylate polymer is a linear or branched C₁-C₂₂ alkyl, a linear or branched C₁-C₂₂ alkoxyl, linear or branched C₁-C₂₂ acyl, and mixtures thereof; if R is selected as being branched, the branch may comprise from 1 to 4 carbon atoms; preferably R of the hydrophobic polyamine ethoxylate polymer is a linear C₁₂ to C₁₈ alkyl. The alkyl, alkoxyl, and acyl may be saturated or unsaturated, preferably saturated. The n index of the hydrophobic polyamine ethoxylate polymer is from about 2 to about 9.

Q of the hydrophobic polyamine ethoxylate polymer is independently selected from an electron pair, hydrogen, methyl, ethyl, and mixtures thereof. If the formulator desires a neutral backbone of the hydrophobic polyamine ethoxylate, Q of the hydrophobic polyamine ethoxylate polymer should be selected to be an electron pair or hydrogen. Should the formulator desire a quaternized backbone of the hydrophobic polyamine ethoxylate; at least on Q of the hydrophobic polyamine ethoxylate polymer should be chosen from methyl, ethyl. The m index of the hydrophobic polyamine ethoxylate polymer is from 2 to 6. The index x of the hydrophobic polyamine ethoxylate polymer is independently selected to average from about 1 to about 70 ethoxy units.

The ethoxy units of the hydrophobic polyamine ethoxylate may be further modified by independently adding an anionic capping unit to any or all ethoxy units. Suitable anionic capping units include sulfate, sulfosuccinate, succinate, maleate, phosphate, phthalate, sulfocarboxylate, sulfodicarboxylate, propanesultone, 1,2-disulfopropanol, sulfopropylamine, sulphonate, monocarboxylate, methylene carboxylate, carbonates, mellitic, pyromellitic, citrate, acrylate, methacrylate, and mixtures thereof. Preferably the anionic capping unit is a sulfate.

In another embodiment, the nitrogens of the hydrophobic polyamine ethoxylate polymer are given a positive charge through quaternization. As used herein “quaternization” means quaternization or protonization of the nitrogen to give a positive charge to the nitrogens of the hydrophobic polyamine ethoxylate.

Polyamino acids—The soil suspending polymers can be derived from L-glumatic acid, D-glumatic acid or mixtures, e.g. racemates, of these L and D isomers. The polymers include not only the homopolymers of glutamic acid but also copolymers, such as block, graft or random copolymers, containing glutamic acid. These include, for example, copolymers containing at least one other amino acid, such as aspartic acid, ethylene glycol, ethylene oxide, (or an oligimer or polymer of any of these) or polyvinyl alcohol. Glutamic acid can, of course, carry one or more substituents including, for example, alkyl, hydroxy alkyl, aryl and arylalkyl, commonly with up to 18 carbon atoms per group, or polyethylene glycol attached by ester linkages. See U.S. Pat. No. 5,470,510 A, issued Nov. 28, 1995.

Polyamine N-oxide polymers—The polyamine N-oxide polymers suitable for use herein contain a polymerisable unit, whereto an N-oxide group can be attached to or wherein the N-oxide group forms part of the polymerisable unit or a combination of both. Suitable polyamine N-oxides wherein the N-oxide group forms part of the polymerisable unit comprise polyamine N-oxides wherein the N-oxide group comprises part of a heterocyclic group such as pyridine, pyrrole, imidazole, pyrrolidine, piperidine, quinoline, acridine and derivatives thereof. Another class of said polyamine N-oxides comprises the group of polyamine N-oxides wherein the N-Oxide group is attached to the polymerisable unit. Preferred class of these polyamine N-oxides are the polyamine N-oxides.

Any polymer backbone can be used as long as the amine oxide polymer formed has dye transfer inhibiting properties. Examples of suitable polymeric backbones are polyvinyls, polyalkylenes, polyesters, polyethers, polyamide, polyimides, polyacrylates and mixtures thereof. The amine N-oxide polymers of the present invention typically have a ratio of amine to the amine N-oxide of about 10:1 to about 1:1000000. However the amount of amine oxide groups present in the polyamine oxide polymer can be varied by appropriate copolymerization or by appropriate degree of N-oxidation. The soil suspending polymers encompass random or block copolymers where one monomer type is an amine N-oxide and the other monomer type is either an amine N-oxide or not. The amine oxide unit of the polyamine N-oxides has a pKa <10, pKa <7, and pKa <6. The polyamine oxides can be obtained in almost any degree of polymerization. The degree of polymerization is not critical provided the material has the desired soil-suspending power. Typically, the average molecular weight is within the range of about 500 to about 1000,000.

N-Vinylimidazole N-Vinylpyrrolidone Copolymers—Suitable soil suspending polymers for use in the cleaning compositions are selected from N-vinylimidazole N-vinylpyrrolidone copolymers wherein a molar ratio of N-vinylimidazole to N-vinylpyrrolidone from about 1 to about 0.2, and the polymer has an average molecular weight range from about 5,000 to about 50,000. The average molecular weight range was determined by light scattering as described in Barth H. G. and Mays J. W. Chemical Analysis Vol 113, “Modern Methods of Polymer Characterization”.

Polyvinylpyrrolidone—Another suitable soil suspending polymer for use herein comprise a polymer selected from polyvinylpyrrolidone (“PVP”) having an average molecular weight from about 2,500 to about 400,000. Suitable polyvinylpyrrolidones are commercially available from ISP Corporation, New York, N.Y. and Montreal, Canada under the product names PVP K-15 (viscosity molecular weight of 10,000), PVP K-30 (average molecular weight of 40,000), PVP K-60 (average molecular weight of 160,000), and PVP K-90 (average molecular weight of 360,000). Other suitable polyvinylpyrrolidones which are commercially available from BASF Cooperation include Sokalan® HP 165 and Sokalan® HP 12; polyvinylpyrrolidones known to persons skilled in the detergent field (see for example EP-A-262,897 and EP-A-256,696).

Polyvinyloxazolidone and Polyvinylimidazole—Other suitable soil suspending polymers for use herein include polyvinyloxazolidone having an average molecular weight from about 2,500 to about 400,000 and polyvinylimidazole having an average molecular weight from about 2,500 to about 400,000.

Chelants—In one optional embodiment, the performance additive may comprise one or more chelants. Chelants are distinguished from common builders such as citrate in that they preferentially bind transition metals. Suitable levels of chelants in the compact fluid laundry detergents are from about 0001% to about 5%, more specifically from about 0.5% to about 4%, even more specifically from about 0.1% to about 2%.

Non-limiting examples of suitable chelants include, S,S-ethylenediamine disuccinic acid (EDDS), Tiron® (otherwise know as Catechol-2,5-disulfonate as the acid or water soluble salt), ethylenediamine tetraacetic acid (EDTA), Diethylenetriaminepentaacetate (DTPA), 1-Hydroxyethylidene 1,1 diphosphonic acid (HEDP), Diethylenetriamine-penta-methylene phosphonic acid (DTPMP), dipicolinic acid and salts and/or acids thereof and mixtures thereof. Chelants may be formulated conveniently in any suitable form such as the acid form, or water soluble form, such as sodium, potassium, ammonium, or substituted ammonium and combinations thereof. Further examples of suitable chelants and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876.

Other chelants useful herein are the water-soluble polyphosphonates, including specifically sodium, potassium and lithium salts of methylene diphosphonic acid; sodium, potassium and lithium salts of ethylene diphosphonic acid; and sodium, potassium and lithium salts of ethane-I,I,2-triphosphonic acid. Other examples include the alkali metal salts of ethane-2-carboxy-1,1-diphosphonic acid hydroxymethanediphosphonic acid, carboxyldiphosphonic acid, ethane-1-hydroxy-I,I,2-triphosphonic acid, ethane-2-hydroxy-1,I,2-triphosphonic acid, propane-1,1,3,3-tetraphosphonic acid, propane-1,1,2,3-tetraphosphonic acid, and propane-1,2,2,3-tetra-phosphonic acid.

Enzymes—In one embodiment, the performance additive may comprise one or more enzymes. Suitable levels of enzymes in the compact fluid laundry detergents are from about 0.001% to about 5% by weight of the compact fluid laundry detergent composition, of detersive enzymes. Percentages by weight of enzymes unless, otherwise specifically indicated, are percentages by weight of commercial enzyme preparations and not percentages by weight of active enzyme.

Enzyme materials useful for liquid detergent formulations, and their incorporation into such formulations, are disclosed in U.S. Pat. No. 4,261,868, Hora et al, and in U.S. Pat. No. 4,507,219, Hughes.

In another embodiment, the enzyme may be selected from protease, cutinase, hemicellulase, peroxidases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, lactase, amylase and mixtures thereof.

Specific examples of lipase enzymes includes: lipase ex Pseudomonas fluorescens IAM 1057 (available from Amano Pharmaceutical Co., Nagoya, Japan, under the tradename Amano-P lipase), the lipase ex Pseudomonas fragi FERM P 1339 (available under the trade-name Amano B), the lipase ex Pseudomonas nitroreducens var. lipolyticum FERM P1338, the lipase ex Pseudomonas sp. (available under the tradename Amano CES), the lipase ex Pseudomonas cepacia, lipases ex Chromobacter viscosum, e.g. Chromobacter viscosum var. lipolyticum NRRL B-3673, commercially available from Toyo Jozo Co., Tagata, Japan; further Chromobacter viscosum lipases from U.S. Biochemical Corp. USA and Diosynth Co., The Netherlands, and lipases ex Pseudomonas gladioli; and ex Humicola lanuginosa available from Amano under the tradename Amano CE.

A non-limiting list of suitable commercially available non-protease enzymes include: Amylases (α and/or β) are described in WO 94/02597 and WO 96/23873. Commercial examples are Purafect Ox Am® [Genencor] and Termamyl®, Natalase®, Ban®, Fungamyl® and Duramyl® [all ex Novozymes]. Cellulases include bacterial or fungal cellulases, e.g. produced by Humicola insolens, particularly DSM 1800, e.g. 50 Kda and ˜43 kD [Carezyme®]. Also suitable cellulases are the EGIII cellulases from Trichoderma longibrachiatum. Suitable lipases include those produced by Pseudomonas and Chromobacter groups. Preferred are e.g. Lipolase®, Lipolase Ultra®, Lipoprime® and Lipex® from Novozymes. Also suitable are cutinases [EC 3.1.1.50] and esterases. Carbohydrases e.g. mannanase (U.S. Pat. No. 6,060,299), pectate lyase (WO99/27083) cyclomaltodextringlucanotransferase (WO96/33267) xyloglucanase (WO99/02663). Bleaching enzymes eventually with enhancers include e.g. peroxidases, laccases, oxygenases, (e.g. catechol 1,2 dioxygenase, lipoxygenase (WO 95/26393), (non-heme) haloperoxidases.

Illustrative non-limiting examples of commercially available proteases, include, Alcalase®, Savinase®, Kannase®, Everlase®, Esperase® commercially available from Novozymes; Purafect®, Purafext Ox®, Properase® commercially available from Genencor; BLAP and BLAP variants commercially available from Henkel; Maxatase and Maxacal of commercially available from Gist-Brocades; Kazusase of Showa Denko; and K-16-like proteases commercially available from KAO. Additional illustrative proteases are described in e.g. EP130756, WO91/06637, WO95/10591, WO99/20726, U.S. Pat. No. 5,030,378 (Protease “A”) and EP251446 (Protease “B”).

Aesthetics—The compact fluid laundry detergent composition and the water insoluble container may have any desired appearance or aesthetics. The compact fluid laundry detergent composition water and the insoluble container may be opaque, transparent or translucent, of any color or appearance, such as a pearlescent liquid. In one embodiment, the compact fluid laundry detergent composition may contain air or gas bubbles, suspended liquid droplets, simple or multiple emulsion droplets, suspended particles and the like and combinations thereof. Suitable sizes include from about 0.1 microns to about 5 mm, more specifically from about 20 microns to about 1 mm. These optional suspended liquids and/or particles may be visible as discrete entities, i.e. different color, shape, texture, and the like and combinations thereof. These suspended liquids and/or particles may be a different color, texture or some other visually distinguishing feature than the other portions of the compact fluid laundry detergent composition.

Additionally, the water insoluble container and the compact fluid laundry detergent composition may be any color or combination of colors. It is also to be understood that the term “color” not only includes all the colors of the visible spectrum, namely, red, orange, yellow, green, blue, teal, brown, purple, lilac, sea green, tan, navy, violet, pink and the like, it also includes all shades, tones, hues and the like, such as dark blue, light, blue, light green, etc, of these colors, as well as black, white, and grey and all shades, tones, hues and the like of these. Furthermore, the water insoluble container and the compact fluid laundry detergent composition may also in addition have any additional visual treatments, such as for example, a combination of varied refractive indices, pearlescence, opalescence, reflective, holographic effect, metallic color, gloss finish, matte finish and the like and combinations thereof.

In another embodiment, the compact fluid laundry detergent composition may comprise two or more visually distinctive regions. Each region can itself comprise one or more distinct physical phases. The term “visually distinctive” as used herein describes compositions in the water insoluble container or upon being dispensed that display visually different regions. These different regions are either distinctively separate or partially mixed as long as the compact fluid laundry detergent composition remains visible to the naked eye. The combination of these visually distinctive regions can be chosen to produce any of a wide variety of patterns, including for example: striped, marbled, rectilinear, interrupted striped, check, mottled, veined, clustered, speckled, geometric, spotted, ribbons, helical, swirl, arrayed, variegated, textured, grooved, ridged, waved, sinusoidal, spiral, twisted, curved, cycle, streaks, striated, contoured, anisotropic, laced, weave or woven, basket weave, spotted, and tessellated. The pattern may be striped and may be relatively uniform and even across the dimension any container. Alternatively, the striped pattern may be uneven, i.e. wavy, or may be non-uniform in dimension. The striped pattern does not need to necessarily extend across the entire dimension of any container.

The term “stripe” as used herein means that each phase present in the compact fluid laundry detergent composition occupies separate but distinct physical spaces inside the water insoluble container in which it is stored, but are in direct contact with one another. (i.e. they are not separated by a barrier and they are not emulsified or mixed to any significant degree). The stripes may be relatively uniform and even across the dimension of the water insoluble container. Alternatively the stripes may be uneven, i.e. wavy, or may be non-uniform in dimension. The stripes do not necessarily extend across the entire dimension of the water insoluble container. The “stripe’ can comprise various geometric patterns, various colors and, or glitter or pearlescence, providing that the concentration of these forms visually distinct bands or regions.

The term “marbling” as used herein refers to a striped design with a veined and/or mottled appearance similar to marble.

While many variations in the physical characteristics of the components are possible, i.e., color, viscosity, rheology, texture, density etc, variations in color are widely sought. The specific design or pattern achieved (i.e., width, length of stripe or marbling etc.) in the compact fluid laundry detergent composition can be varied by varying a number of factors for example, rheological characteristics of the phases, diameter of the dispensing means, presence or absence of rotation of the container during filling, rate of speed and constancy and the like and combinations thereof.

Lyotropic liquid crystalline mesophases—Without intending to be limited by theory, the compact fluid laundry detergents herein can include, or not include, by way of physical mesostructure, any of the well-known lyotropic liquid crystalline mesophases, for example as described in “Handbook of Applied Surface and Colloid Chemistry”, Ed. K. Holmberg, ISBN 0471 490830, published by John Wiley and Sons, New York, N.Y., 2001, incorporated herein by reference in its entirety. See especially Chapter 16, “Identification of Lyotropic Crystalline Mesophases”, by Stephen T. Hyde.

Embodiments of compact fluid laundry detergents herein include L-alpha phases otherwise known as lamellar mesophases, L-beta phases otherwise known as gel mesophases, and mixtures thereof. Further embodiments are characterized by the presence of lamellar mesophases having no detectable gel phase, or by lamellar mesophases free from maltese cross textures in the optical microscope. In other embodiments, maltese cross textures may appear after applying shear to the compositions. In certain typical embodiments, no folding into vesicles or spherical globules is observed.

In general, as will be noted from the recital of specific surfactants or amphiphiles herein, the present compositions rely principally on single-chain surfactants, amphiphiles or detergents, although the mesostructure may be modified by the inclusion of limited proportions of double-tailed surfactants. Moreover, embodiments herein are characterized by the presence of a topological defect-rich lamellar mesophase with relatively low degree of folding. See the above identified reference at page 308, Section 2.1.3, Lamellar mesophases, and subsequent discussion in the same chapter of defect structure.

Adjuncts—The compact detergent composition and methods of the present invention may comprise one or more adjuncts to give it additional desired properties, of functional and/or aesthetic nature.

Perfumes—As used herein “perfume” refers to in its broadest sense to include any substance that diffuses or imparts an agreeable or attractive scent and includes pro-perfume. Perfumes and perfumery ingredients useful in the present compositions and processes comprise a wide variety of natural and synthetic chemical ingredients, including, but not limited to, aldehydes, ketones, esters, enduring perfume ingredients, blooming perfume ingredients, low odor detection threshold perfume ingredients, natural perfume oil ingredient, and the like. In one embodiment, the perfume comprises at least one essential oil. In another embodiment, the perfume comprises an extract. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Additional information on perfumes and components thereof can be found in U.S. Patent Application Publication No. 2003/0104969 A1, U.S. Pat. Nos. 6,194,362; U.S. Pat. No. 6,143,707; U.S. Pat. No. 6,491,728; U.S. Pat. No. 5,378,468; U.S. Pat. No. 5,626,852; U.S. Pat. No. 5,710,122; U.S. Pat. No. 5,716,918; U.S. Pat. No. 5,721,202; U.S. Pat. No. 5,744,435; U.S. Pat. No. 5,756,827; U.S. Pat. No. 5,830,835; U.S. Pat. No. 5,919,752; WO 00/02986 published Jan. 20, 2000; and WO 01/04248 published Jan. 18, 2001.

In one embodiment, the perfume is encapsulated, such as a perfume micro capsule.

Perfumes typically comprise from about 0.001% to about 3%, by weight, of the compositions herein.

Hydrotropes—In one embodiment, the adjunct comprises a hydrotrope. Hydrotrope reduces liquid crystal formation. Illustrative hydrotropes include urea, toluene sulphonate, xylene sulphonate, cumene sulphonate and mixtures thereof. Illustrative salts include sodium, potassium, ammonium, monoethanolamine, triethanolamine and mixtures thereof. In one embodiment, the hydrotrope is selected from xylene sulfonate, urea and combinations thereof. In one embodiment, the amount of the optional hydrotrope may be in the range of from about 0 to about 10%, more specifically from about 0 to 5%, even more specifically from about 0 to about 2%, even more specifically still from about 0 to about 1%.

Organic External Structurant—Surprisingly it has been found that compact fluid laundry detergents herein do not require an organic external structurant. Preferred embodiments of the invention are substantially free from organic external structurant. If desired, organic external structurants can be incorporated, for example to adjust the rheology of specific aesthetic embodiments. Such structurants, if used, will comprise from about 0.01% to about 1% by weight, more specifically from about 0.015% to about 0.75% by weight, even more specifically from about 0.02% to about 0.5% by weight of the compositions herein.

An “external” structurant as defined herein is a material which has as its primary function that of providing rheological alteration, typically to increase viscosity of a fluid such as a liquid or gel or paste. External structurants suitable herein do not, in and of themselves, provide any significant fabric cleaning or fabric care benefit. An external structurant is thus distinct from an “internal” structurant which, while it can also alter matrix rheology, has been incorporated into the liquid product for some additional primary purpose. Thus, for example, an internal structurant can be an anionic surfactant which can serve to alter rheological properties of liquid detergents, but which have been added to the product primarily to act as types of cleaning ingredients.

One type of external structuring agent useful in the compositions of the present invention comprises non-polymeric (discounting alkoxylation which may be included), crystalline hydroxy-functional materials which can form thread-like structuring systems throughout the liquid matrix when they are crystallized within the matrix in situ. Such materials can be generally characterized as crystalline, hydroxyl-containing fatty acids, fatty esters or fatty waxes. Such materials will generally be selected from those having the following formulas: 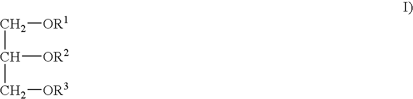
wherein: 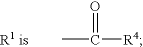
R² is R¹ or H; R³ is R¹ or H; R⁴ is independently C₁₀-C₂₂ alkyl or alkenyl comprising at least one hydroxyl group;
II) 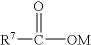
wherein: 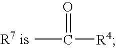
R⁴ is as defined above in i); M is Na⁺, K⁺, Mg⁺⁺ or Al³⁺, or H; and
III) Z-(CH(OH))a-Z′ wherein: a is from 2 to 4, specifically 2; Z and Z′ are hydrophobic groups, especially selected from C₆-C₂₀ alkyl or cycloalkyl, C₆-C₂₄ alkaryl or aralkyl, C₆-C₂₀ aryl or mixtures thereof. Optionally Z can contain one or more nonpolar oxygen atoms as in ethers or esters.

Materials of the Formula I type are preferred. They can be more particularly defined by the following formula: 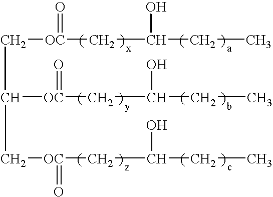
wherein: (x+a) is from between 11 and 17; (y+b) is from between 11 and 17; and (z+c) is from between 11 and 17. Specifically, in this formula x=y=z=10 and/or a=b=c=5.

Specific examples of preferred crystalline, hydroxyl-containing structurants include castor oil and its derivatives. Especially preferred are hydrogenated castor oil derivatives such as hydrogenated castor oil and hydrogenated castor wax. Commercially available, castor oil-based, crystalline, hydroxyl-containing structurants include THIXCIN™ from Rheox, Inc. (now Elementis).

Alternative commercially available materials that are suitable for use as crystalline, hydroxyl-containing structurants are those of Formula III hereinbefore. An example of a structurant of this type is 1,4-di-O-benzyl-D-threitol in the R,R, and S,S forms and any mixtures, optically active or not.

All of these crystalline, hydroxyl-containing structurants as hereinbefore described are believed to function by forming thread-like structuring systems when they are crystallized in situ within the aqueous liquid matrix of the compositions herein or within a pre-mix which is used to form such an aqueous liquid matrix. Such crystallization is brought about by heating an aqueous mixture of these materials to a temperature above the melting point of the structurant, followed by cooling of the mixture to room temperature while maintaining the liquid under agitation.

Under certain conditions, the crystalline, hydroxyl-containing structurants will, upon cooling, form the thread-like structuring system within the aqueous liquid matrix. This thread-like system can comprise a fibrous or entangled thread-like network. Non-fibrous particles in the form of “rosettes” may also be formed. The particles in this network can have an aspect ratio of from about 1.5:1 to about 200:1, more specifically from about 10:1 to about 200:1. Such fibers and non-fibrous particles can have a minor dimension which ranges from about 1 micron to about 100 microns, more specifically from about 5 microns to about 15 microns.

Illustrative exemplary crystalline, hydroxyl-containing structurants, and their incorporation into aqueous shear-thinning matrices, are described in greater detail in U.S. Pat. No. 6,080,708 and in PCT Publication No. WO 02/40627.

Other types of organic external structurants, besides the non-polymeric, crystalline, hydroxyl-containing structurants described hereinbefore, may be utilized in the liquid detergent compositions herein. For example suitable polymeric structurants include those of the polyacrylate, polysaccharide or polysaccharide derivative type. Polysaccharide derivatives typically used as structurants comprise polymeric gum materials. Such gums include pectine, alginate, arabinogalactan (gum Arabic), carrageenan, gellan gum, xanthan gum and guar gum.

If polymeric structurants are employed herein, a preferred material of this type is gellan gum. Gellan gum is a heteropolysaccharide prepared by fermentation of Pseudomonaselodea ATCC 31461. Gellan gum is commercially marketed by CP Kelco U.S., Inc. under the KELCOGEL tradename. Processes for preparing gellan gum are described in U.S. Pat. Nos. 4,326,052; 4,326,053; 4,377,636 and 4,385,123.

Of course, any other structurants besides the foregoing specifically described materials can be employed. Examples of such structurants further include “organogellants” or “organogelators”.

Boric acid derivatives and/or pH jump systems—One specific optional adjunct ingredient may be a boric acid derivative, the use of which is known e.g., for enzyme stabilization. Combinations of borates and polyols, especially sorbitol, constitute pH jump systems which are also known in the art, e.g., U.S. Pat. Nos. 5,089,163 and 4,959,179 to Aronson et al. The inclusion of pH jump systems herein is not preferred. In another embodiment, the compact fluid laundry detergent is substantially free of pH jump systems, such as, the aforementioned borax sorbitol pH jump system or the like.

In one embodiment, the compositions and methods described herein, may comprise less than about 3%, by weight of the detergent composition, more specifically less than about 1%, by weight of the detergent composition, even more specifically is substantially free of boric acid derivatives.

By “boric acid derivatives” it is meant boron containing compounds such as boric acid per se, substituted boric acids and other boric acid derivatives that at least a part of which are present in solution as boric acid or a chemical equivalent thereof, such as a substituted boric acid. Illustrative examples of boric acid derivatives includes boric acid, boric oxide, borax, alkali metal borates (such as sodium ortho-, meta- and pyroborate and sodium pentaborate), and mixtures thereof.

As noted herein, these boric acid derivatives have in the past been used in combination with organic polyol solvents, such as sorbitol, as a pH jump system. The present compact fluid laundry detergent compositions means that the need for a pH jump system, and consequently the use of these boric acid derivatives can be reduced, thereby saving money and time.

Neutralizers—In one embodiment, the adjunct may be a neutralizer. The neutralizers may be acidic or alkali in character depending upon what they will be neutralizing. Illustrative suitable neutralizers include, alkali metal hydroxides, such as NaOH, LiOH, KOH etc; alkaline earth hydroxides, such as Mg(OH)₂, Ca(OH)₂; ammonium or substituted ammonium hydroxides; alkanolamines, such as, mono-, di- and triethanolamines for example monoethanolamine (MEA); inorganic acids such as, sulfuric acid, hydrochloric acid, nitric acid; organic acids, such as acetic acids, citric acid, lactic acid and the like, and combinations thereof.

These neutralizers may be optionally present in any composition or method specifically from about 0.0001% to about 75%, more specifically from about 0.001% to about 30%, by weight of the compact detergent composition.

Colorants—In one embodiment, the compact fluid laundry detergent composition comprises a colorant, more specifically a colorant in at least one visually distinctive region of the compact fluid laundry detergent composition. The composition comprises from about 0.00001% to about 10%, by weight of the composition of a colorant.

The colorant, in a one specific embodiment, comprises metal ions. More specifically, the colorant is free of barium and aluminum ions which allows for improved lamellar phase stability. The colorant more specifically maintains UV stability.

Colorants suitable for use in the compact fluid laundry detergent composition may be selected from organic pigments, inorganic pigments, interference pigments, lakes, natural colorants, pearlescent agents, dyes, carmines, and mixtures thereof. Dyes which are not destroyed by UV light may also be used if desired.

Non limiting examples of hueing dyes useful herein include Basic Violet 3 (Cl-42555) and Basic Violet 4 (Cl 42600), both commercially available from Standard Dyes.

In one embodiment, the composition compromises a nonstaining dye and a dye color fidelity stabilizer, even more specifically the dye color fidelity stabilizer is a reducing agent, even more specifically sodium bisulfite. As used herein, “nonstaining dye” refers to any dye added for purely aesthetic purposes to the compact fluid laundry detergent and wherein such dye produces no permanent marks on white cotton which is brought directly into contact with an undiluted form of the compact fluid laundry detergent composition. This ensures that the compact fluid laundry detergent composition can be used for direct pretreatment of soiled fabrics, that is, the compact fluid laundry detergent composition can be used as a laundry pretreater.

In another embodiment, the compact fluid laundry detergent composition is substantially free of any dyes. This compact fluid laundry detergent composition can also be used for direct pretreatment of soiled fabrics, that is, the compact fluid laundry detergent composition can be used as a laundry pretreater.

Other Adjuncts—In one embodiment of the instant invention, the adjunct ingredient may be selected from builders, brightener, dye transfer inhibitor, chelants, polyacrylate polymers, dispersing agents, colorant dye, hueing dyes, perfumes, processing aids, bleaching additives, bleach activators, bleach precursors, bleach catalysts, solvents, co-solvents, hydrotropes, liquid carrier, phase stabilizers, soil release polymers, enzyme stabilizers, enzymes, soil suspending agents, anti-redeposition agents, deflocculating polymers, bactericides, fungicides, UV absorbers, anti-yellowing agents, anti-oxidants, optical brighteners, suds suppressors, opacifiers, suds boosters, anticorrosion agents, radical scavengers, chlorine scavengers, structurants, fabric softening additives, other fabric care benefit agents, pH adjusting agents, fluorescent whitening agents, smectite clays, structuring agents, preservatives, thickeners, coloring agents, fabric softening additives, rheology modifiers, fillers, germicides and mixtures thereof. Further examples of suitable adjunct ingredient and levels of use are described in U.S. Pat. No. 3,936,537, issued Feb. 3, 1976 to Baskerville, Jr. et al.; U.S. Pat. No. 4,285,841, Barrat et al., issued Aug. 25, 1981; U.S. Pat. No. 4,844,824 Mermelstein et al., issued Jul. 4, 1989; U.S. Pat. No. 4,663,071, Bush et al.; U.S. Pat. No. 4,909,953, Sadlowski, et al. issued Mar. 20, 1990; U.S. Pat. No. 3,933,672, issued Jan. 20, 1976 to Bartoletta et al.; U.S. Pat. No. 4,136,045, issued Jan. 23, 1979 to Gault et al; U.S. Pat. No. 2,379,942; U.S. Pat. No. 3,308,067; U.S. Pat. No. 5,147,576 to Montague et al; British Pat. No. 1,470,250; British Patent No. 401,413 to Marriott; British Patent No. 461,221 to Marriott and Guam British Patent No. 1,429,143; and U.S. Pat. No. 4,762,645, Tucker et al, issued Aug. 9, 1988.)

Examples of suitable builders which may be used include water-soluble alkali metal phosphates, polyphosphates, borates, silicates and also carbonates; water-soluble amino polycarboxylates; water-soluble salts of phytic acid; polycarboxylates; zeolites or aluminosilicates and combinations thereof. Specific examples of these are: sodium and potassium triphosphates, pyrophosphates, orthophosphates, hexametaphosphates, tetraborates, silicates, and carbonates; water-soluble salts of mellitic acid, citric acid, and carboxymethyloxysuccinic acid, salts of polymers of itaconic acid and maleic acid, tartrate monosuccinate, tartrate disuccinate.

These adjuncts may be optionally present in any composition or method of the present invention from about 0.0001% to about 95%, specifically from about 0.001% to about 70%, by weight of the compact detergent composition.

The list of adjuncts herein is not intended to be exhaustive and other unlisted adjuncts well known in the art, may also be included in the composition.

Water Insoluble Container—In one embodiment, the compact fluid laundry detergent may be releasably stored in a water insoluble container. As used herein “water insoluble container” refers to a container that does not lose its shape, typically its capability to be in direct contact with the compact fluid laundry detergent and releasably store the compact fluid laundry detergent, while any compact fluid laundry detergent remains in the water insoluble container. Specifically, this means that the water insoluble material comprises a material which is insoluble in water.

The water insoluble container may be made of any suitable material such as, glass, metal, polymer and the like and combinations thereof. In one embodiment, the water insoluble container comprises a polymeric material, although other packages such as paperboard cartons with film lining and glass bottles may be used. In one embodiment, the water insoluble container, is a polymeric material selected from polypropylene (PP), polyethylene (PE), polycarbonate (PC), polyamides (PA) polyethylene terephthalate (PET), polyvinylchloride (PVC), polystyrene (PS), and combinations thereof.

In one embodiment, the water insoluble container may be at least partially, more specifically totally transparent or translucent. In another embodiment, the water insoluble container may be at least partially, more specifically totally opaque. In another embodiment, the water insoluble container is substantially opaque and contains a transparent or translucent portion or window which is capable of providing information on how much compact fluid laundry detergent composition is present in the water insoluble container. This transparent or translucent portion or window may be of any suitable size or shape as long as it provides enough information on how much compact fluid laundry detergent composition is present in the water insoluble container. In another embodiment, a magnifying window can be placed on the water insoluble container so that the contents are more readily visible.

The water insoluble container of the present invention may be of any form or size suitable for storing and packaging liquids for household use. For example, in one embodiment, the water insoluble container has a capacity of 100 ml to 3000 ml, more specifically 250 ml to 1500 ml.

The water insoluble container may be formed by any suitable process, such as, thermoforming, blow molding, injection molding, injection-stretch blow bolding (ISBM) or the like.

In another embodiment, the water insoluble container has a means suitable for pouring the composition and means for reclosing the water insoluble container. The pouring means may be of any size or form but, preferably will be wide enough for conveniently dosing the composition. The optional closing means may be of any form or size but usually will be screwed on, clicked on, or otherwise attached to the container to close the water insoluble. The optional closing means may be cap which can be detached from the water insoluble container. Alternatively, the optional cap can still be attached to the water insoluble container, whether the water insoluble container is open or closed. The optional closing means may also be incorporated in the water insoluble container.

In one embodiment the water insoluble containers typically include an opening for dispensing the composition there through and actuation means for dispensing the composition. One illustrative type of water insoluble containers is the so called squeeze containers. Squeeze containers are usually formed from a resiliently deformable material and have an opening, more specifically at the top, side and/or bottom of the container that may have a valve to control the flow through the opening.

One type of useful valve is an on-off valve that is actuated by rotating the valve. Another particularly useful valve is a pressure-responsive dispensing valve that controls the flow according to a pressure difference across the valve. Such a valve can be configured to be normally closed and to assume an open configuration when the container is squeezed.

Alternatively, the squeeze containers may be the so called bag in bottle containers or a so called airless bottle container.

Optional features of water insoluble squeeze containers include a cap to prevent loss of the composition between dispensing. Water insoluble containers of rigid materials having pump mechanisms are also suitable for use herein.

In another embodiment, the water insoluble container is capable of preventing olfactory access by a consumer to a head space co-located with the compact fluid laundry detergent composition in the insoluble container during dispensing of the compact fluid laundry detergent. As used herein “preventing olfactory access” refers to the inability of the consumer to have olfactory access, i.e. smell or otherwise detect, the head space of the compact fluid laundry detergent during dispensing. This olfactory access may be prevented by dispensing the compact fluid laundry detergent from a region of the water insoluble container remote from the location of the head space in the container, such as at the bottom, front, and/or side of the container.

In another embodiment, the water insoluble container comprises a deformable container for storing the compact fluid laundry detergent composition and a dispensing cap. The deformable container having a bottom end and an opening in the bottom end, more specifically the opening comprises a slit valve adapted for dispensing, liquids, gels and/or pastes. The dispensing cap being removably attached to the bottom end of the deformable container and covering at least the opening in the bottom end. More specifically the dispensing cap further comprises a closable discharge opening that is in fluid communication with the opening in the bottom end.

In another embodiment, the water insoluble container is capable of delivering a variable amount, or dose, of the compact fluid laundry detergent composition. In another embodiment, the water insoluble container is capable of delivering a premeasured amount, or dose, of the compact fluid laundry detergent composition. In another embodiment, premeasured dose is preset by said container so as to provide units of one-half of a recommended dose.

As used herein “recommended doses” refers to the amount of compact fluid laundry detergent composition that a consumer should use in any particular usage situation. In another embodiment, the article of commerce has the following recommended doses in function of water hardness and soil level: low soil or soft water dosage is 10 ml to 40 ml; medium soil or medium water hardness water dosage 20 to 50 ml; high soil or high water hardness water dosage 30 to 70 ml. In another embodiment, the water insoluble container has a capacity of may contain from about 3 to about 50, specifically from about 6 to about 50, recommended doses of the compact fluid laundry detergent composition. In another embodiment, the water insoluble container has a volume of from 250 ml to 1500 ml and a dose capacity of from about 6 to about 50 recommended doses.

In another embodiment, a dispensing device for dispensing a variable dose of compact fluid laundry detergent composition and for laundering fabrics therewith is provided with the water insoluble container. The dispensing device when present is detachably mounted on the water insoluble container. In one embodiment, the dispensing device is the dispensing cap.

In another embodiment, the water insoluble container, more specifically a dispensing or dosing device, such as a dosing ball, has markings to provide fractions of a recommended dose such that a specified numbers of fractions of the recommended dose are to be used for laundering in hard, medium and soft water. These markings facilitate dose compliance on dosing a compact fluid laundry detergent composition for use in a laundry appliance. In another embodiment, the water insoluble container comprises a dispensing device detachably mounted on the water insoluble container and the dispensing device has said markings thereon.

Illustrative examples of suitable water insoluble containers may be found in U.S. Provisional Application Ser. No. 60/541,114, filed Feb. 2, 2004, entitled “CONTAINER HAVING A HELICAL GRIP,” to Brian Floyd,; U.S. Pat. Nos. 4,550,862; and 4,981,239; U.S. Pat. No. 6,705,492, issued on Mar. 16, 2004 to Lowry; U.S. Pat. No. 4,969,581, issued on Nov. 13, 1990 to Seifert et al; U.S. Pat. No. 6,494,346, issued on Dec. 17, 2002 to Gross et al; U.S. Pat. No. 5,626,262, issued on May 6, 1997 to Fitten et al; U.S. Pat. No. 5,655,687, issued on Aug. 12, 1997 to Fitten et al; U.S. Pat. No. 4,728,006, issued on Mar. 1, 1988 to Drobish et al; U.S. Pat. No. 6,269,837, issued on Aug. 7, 2001 to Arent et al; U.S. Pat. No. 4,749,108, issued on Jun. 7, 1988 to Dornsbusch et al; U.S. Pat. No. 6,675,845, issued on Jan. 13, 2004 to Volpenheim et al; U.S. Pat. Nos. 4,732,315; 6,021,926; 6,269,962; 4,846,359; 6,960,375; 6,223,945; 6,902,077; 6,824,001; 6,959,834; 6,491,165; 5,050,742; 6,705,465; 6,630,437; 6,756,350; 6,366,402; 6,159,958; and 6,601,705; WO 92/21569 entitled “Inverted Dispenser”, published Dec. 10, 1992 in the name of Canada Inc; WO 01/04006 entitled “Container”, published Jan. 18, 2001 in the name of Unilever; EP 21,545 published Jan. 7, 1981 in the name of The Procter and Gamble Company; and EP 811,559 published Dec. 10, 1997 in the name of Unilever; and in U.S. Design Pat. Nos. Des. 403,578; Des. 414,421; Des. 425,792; Des. 491,071; Des. 466,816; Des. 457,064; Des. 439,520; Des. 286,602; Des. 429,643; Des. 472,151; Des. 417,622; Des. 322,748; and Des. 509,748. Illustrative examples of water insoluble containers, namely bottom dispensing containers, may also be found in copending U.S. Patent Application No. 60/797,975, entitled “Fabric Treatment Dispensing Package” filed provisionally on 05/05/2006 in the name of Ann Dewree, et. al., Attorney Docket Number 10403P.

In one embodiment, the water insoluble container may have indicia in association therewith. As used herein, “indicia” refers to scent, branding, packaging, properties, sound, words, phrases, letters, characters, brand names, company names, company logos or symbols, descriptions, logos, icons, designs, designer names, symbols, motifs, insignias, figures, marks, signals, colors, textures, shapes, tokens, advertisements, and combinations thereof.

As used herein, “in association with” means the indicia, and the like are either directly printed on, or attached thereto the article of commerce, the water insoluble container itself, or a label attached to said article of commerce or parts thereof and/or are presented in a different manner including, a brochure, print advertisement, electronic advertisement, and/or verbal communication, so as to communicate the indicia to a consumer.

In one embodiment, the indicia in association with the water insoluble container, more specifically the deformable container and/or the dispensing cap via a label. A label provides a convenient point-of-purchase site for the indicia and the like.

In one embodiment, the label is a clear substrate such that the indicia may be printed onto the label and the water insoluble container, more specifically the deformable container and/or the dispensing cap (if the water insoluble container more specifically the deformable container and/or the dispensing cap is transparent/translucent) is substantially visible by the consumer through the label where the indicia is absent. Without wishing to be bound by theory, a clear label may maximize the color of the composition or the tint of the water insoluble container in communicating to the consumer.

In another embodiment, the label has a background color to further communicate to the user. For example, if the scents or scent identifiers are magnolia and orange, the label may have an orange background color to further communicate this scent experience to the user given the visual association of an orange color to orange fruit and/or orange blossoms and hence the orange scent.

In another specific optional embodiment, one or more indicia may be printed directly on the water insoluble container.

In one optional embodiment, the label is “shrink wrapped” on the water insoluble container, more specifically the deformable container and/or the dispensing cap. In another optional embodiment, the label is adhered to the water insoluble container, more specifically the deformable container and/or the dispensing cap by an adhesive.

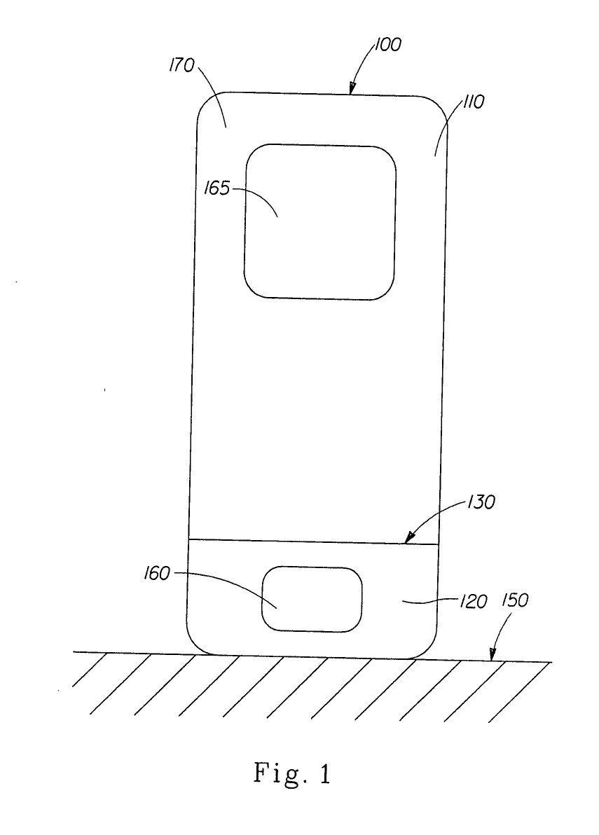

The various different and optional embodiments of the water insoluble container, and/or parts thereof, such as for example the dispensing cap, may be further explained and illustrated with reference to FIGS. 1 to 10.

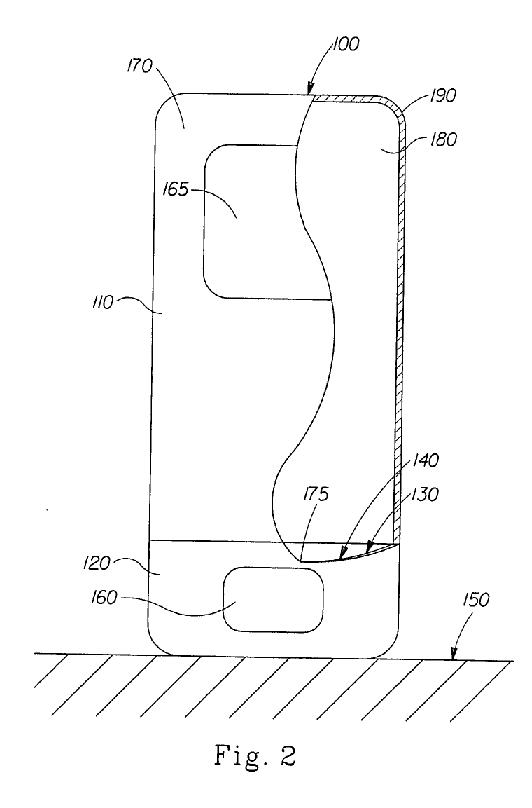

FIG. 1, is one illustrative example of a water insoluble container 100, comprising a deformable container 110 and a dispensing cap 120 which is removably attached thereto. The deformable container 110 has a bottom end 130 with an opening 140 therein (FIG. 2). The dispensing cap 120 is removably attached to the bottom end 130 of the deformable container 110 covering the opening 140. The dispensing cap 120 is also shown resting on the surface 150 in an upright position.

FIG. 1 is an illustrative example of a water insoluble container 100 having indicia 160 and 165 associated therewith. The indicia 160 and 165, which may be the same or different are in association with the deformable container 110 and the dispensing cap 120. In this embodiment, the indicia in association therewith 160 and 165 are two labels which are fastened to the deformable container 110 and the dispensing cap 120 via adhesive.

The deformable container 110 of FIG. 1 also has a top end 170 which is distal to the bottom end 130. The deformable container 110 is also capable of resting on the surface 150 in an upright position with top end 170 contacting the surface 150, that is, now inverted with respect to the deformable container 110 as shown in FIG. 1.

As noted previously any portion of the water insoluble container 100 such as the deformable container 110 and/or the dispensing cap 120 can be translucent or transparent.

FIG. 2, is a section view of one possible embodiment, of the water insoluble container 100 of FIG. 1 along line 2. This section view shows the compact fluid laundry detergent composition 180 and the optional valve 170, through which the compact laundry detergent composition 180 is dispensed. The water insoluble container 100 is also shown in direct contact with and releasably storing the compact fluid laundry detergent composition 180. Also shown is the wall 190 of the deformable container 110.

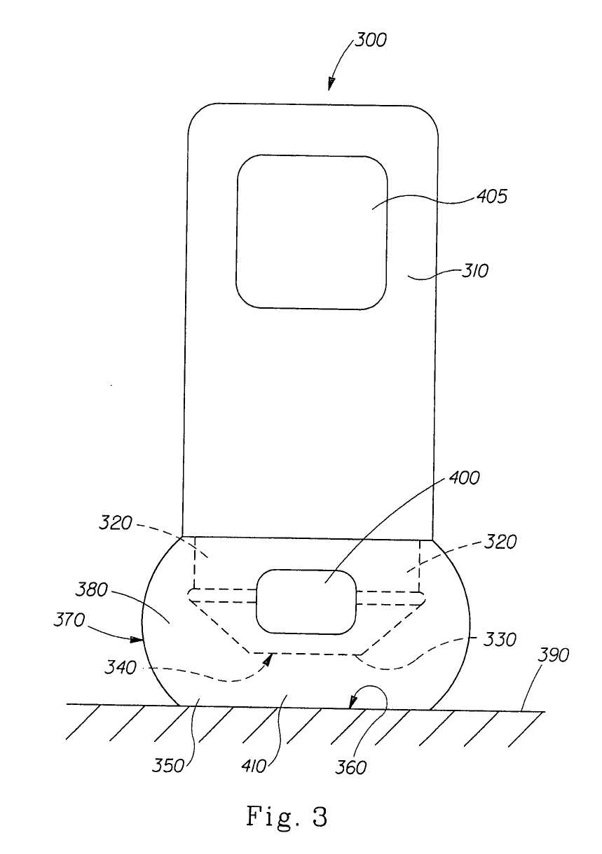

FIG. 3 is another alternative example of a water insoluble container 300, which is a bottom dispensing package comprising a deformable container 310 and a dispensing cap 350 which is removably attached thereto. The deformable container 310 is attached, e.g. by snap fitting, to a dispensing end 320 having a base 330 for supporting the deformable container 310 in an upright position with a dispensing opening 340 therein. The dispensing cap 350 covers the opening 340 and the valve 430 (FIG. 5). The dispensing cap 350 supports the deformable container 310 in an upright position. The dispensing cap 350 is removably attached to the deformable container 310 over the dispensing opening 340 and covering the valve 430 and opening 340. The dispensing cap 350 is formed of a cup shaped member 410 having a face 360 and a cylindrical wall 370 which extends from the face to define an interior 380 of the dispensing cap 350. The face 360 of the dispensing cap 350 is also shown resting on the surface 390 in an upright position. The dispensing cap 350 is capable of receiving and dispensing compact fluid laundry detergent composition 450 (FIG. 5), more specifically dispensing the compact flowable laundry detergent composition 450 within a washing machine.

The water insoluble container 300 having indicia 400 and 405 associated therewith. The indicia 400 and 405, which may be the same or different are in association with the deformable container 310 and the dispensing cap 350. In this embodiment, the indicia in association therewith 400 and 405 are two labels which are fastened to the deformable container 310 and the dispensing cap 350 via adhesive.

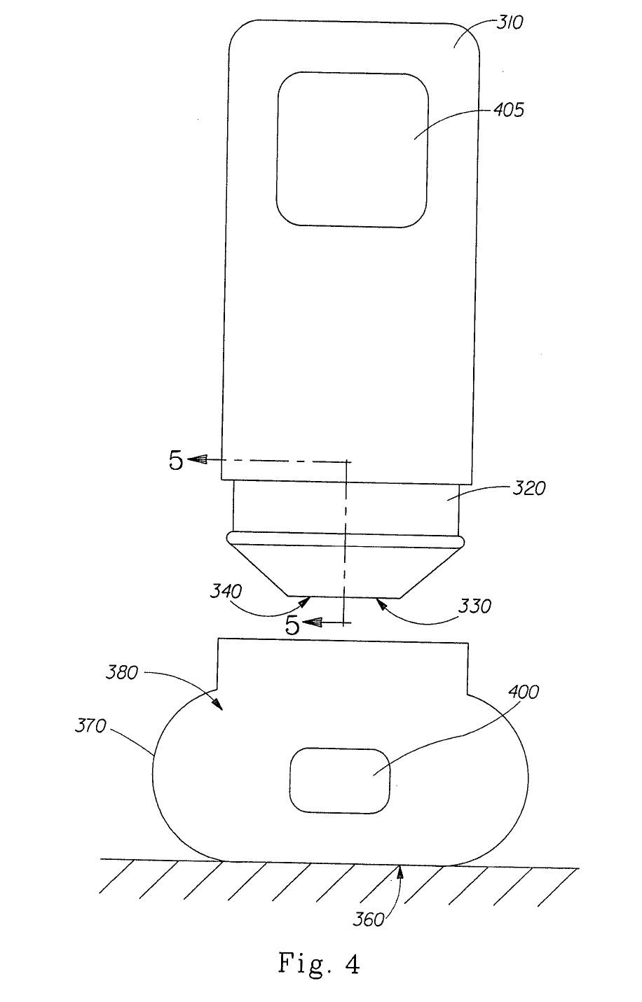

FIG. 4 is an exploded view of the water insoluble container 300 of FIG. 3, which shows the dispensing cap 350 as releasably attached to the deformable container 310.

FIG. 5 is a section view of one possible embodiment, of the water insoluble container 300 of FIG. 4 along line 5. This sectional view shows the inner cavity 440 which is for storing the compact fluid laundry detergent composition 450 and the optional valve 430, through which the compact fluid laundry detergent composition 450 is dispensed. Also shown is the wall 420 of the deformable container 310. The valve 430 is shown in the closed position, such that compact fluid laundry detergent composition 450 is prevented from flowing through the dispensing opening 340.

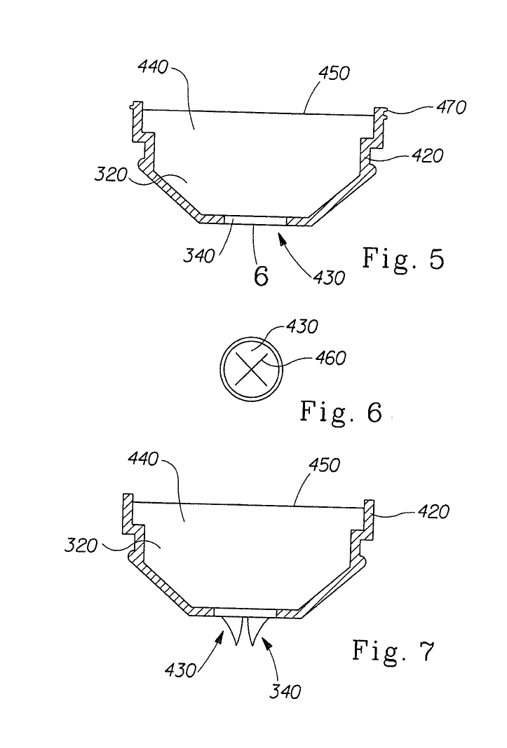

FIG. 6 is a section view of one possible embodiment, of the valve 430 of FIG. 5 along line 6. The valve 430 has a small cross slit 460 therethrough.

FIG. 7 is a section view of one possible embodiment, of the bottom dispensing package 300 of FIG. 4 along line 5. The valve 430 is shown in the open position, such that compact fluid laundry detergent composition 450 is allowed to flow from the inner cavity 440 and through the dispensing opening 340.

The valve 430 in one specific optional embodiment, only allows the compact fluid laundry detergent composition 450 to pass through the dispensing opening 430 when it is subjected to a pressure greater than that of the compact fluid laundry detergent composition 450 under normal gravity.

Alternatively, the valve 430 in another specific optional embodiment, is a bimodal valve wherein the bimodal valve has a first mode of operation capable of retaining the compact fluid laundry detergent composition 450 without leakage when the deformable container 310 is subjected to unintentional external forces, such as can be seen illustrated in FIG. 5, and a second mode of operation capable of dispensing the compact fluid laundry detergent composition 450 when the deformable container 310 is subjected to external forces intentionally applied by a user, such as can be seen illustrated in FIG. 7.

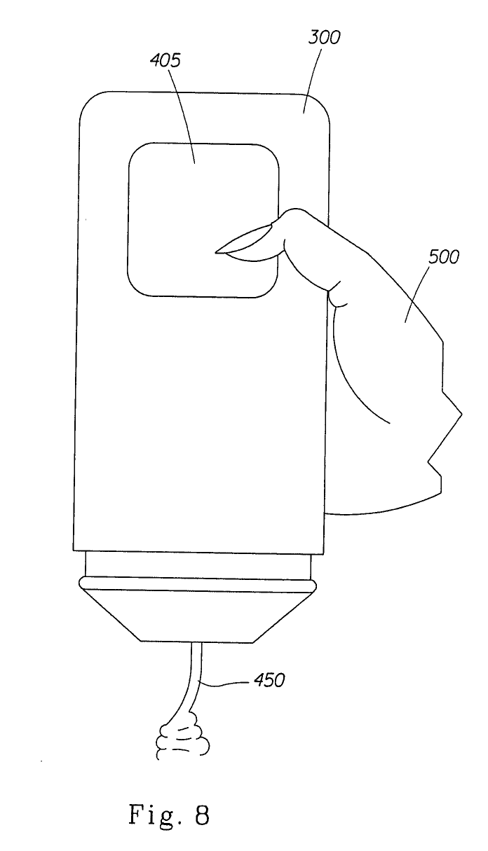

FIG. 8 is an illustrative example of the bottom dispensing package 300 of FIG. 3 being gripped by a human hand 500 and dispensing the compact fluid laundry detergent composition 450. (Note: the human hand or parts thereof, are not part of the scope of the present invention).

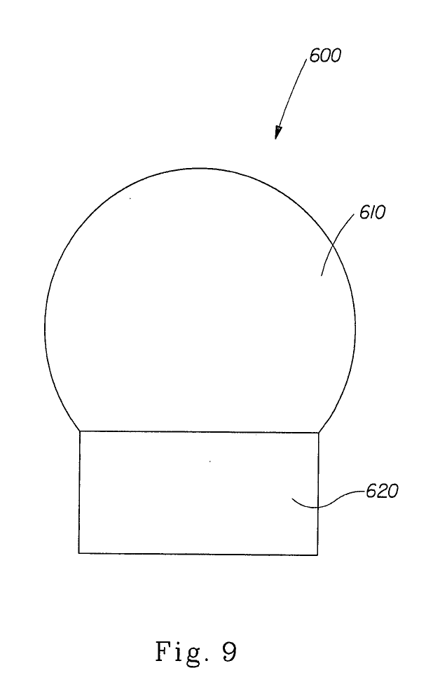

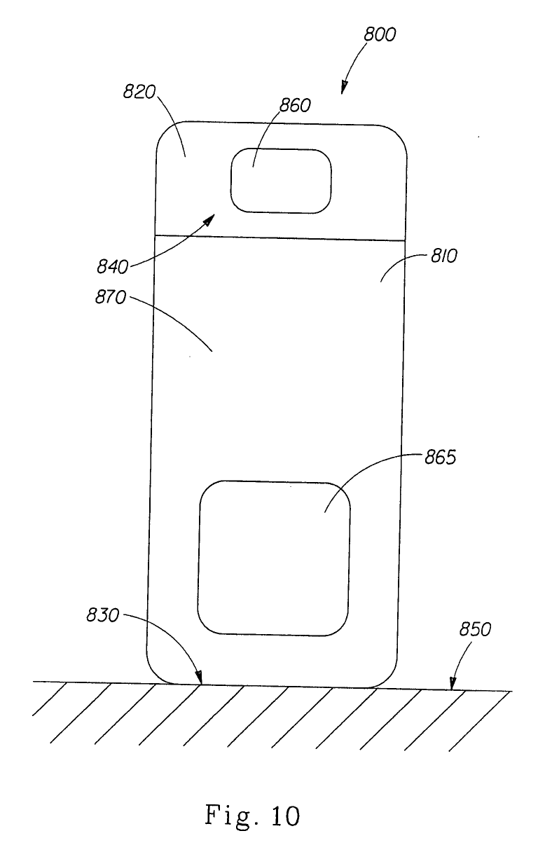

FIG. 9 is an illustrative example of another possible water insoluble container. In FIG. 9, the water insoluble container 600 comprises a side dispensing spherical deformable container 610 and a rectangular dispensing cap 620.

FIG. 10, is another illustrative example of a water insoluble container 800, in this case a top dispensing container comprising a deformable container 810 and a dispensing cap 820 which is removably attached thereto. The deformable container 810 has a top end 870 with an opening 840 therein. The dispensing cap 820 is removably attached to the top end 870 of the deformable container 810 covering the opening 840.

FIG. 10 is an illustrative example of a water insoluble container 800 having indicia 860 and 865 associated therewith. The indicia 860 and 865, which may be the same or different are in association with the deformable container 810 and the dispensing cap 820. In this embodiment, the indicia 860 and 865 in association therewith are two labels which are fastened to the deformable container 810 and the dispensing cap 820 via adhesive.

The deformable container 810 of FIG. 10 also has a bottom end 830 which is distal to the top end 870. The deformable container 110 is also capable of resting on the surface 850 in an upright position with bottom end 830 contacting the surface 850.

As noted previously any portion of the water insoluble container 800 such as the deformable container 810 and/or the dispensing cap 820 can be translucent or transparent.

The water insoluble container may be any size or shape.

Array of Consumer Products—One optional aspect of the present invention comprises an array of consumer products, specifically comprising at least one of articles of commerce described herein. In one embodiment, each of the articles of commerce present in the array of consumer products would be different in some fashion. This difference may be, for example, the shape of the water insoluble container or parts thereof (such as the deformable container and/or dispensing cap), volume of the water insoluble container or parts thereof, dimension of the water insoluble container or parts thereof, color of the water insoluble container or parts thereof, indicia in association with the water insoluble container or parts thereof, different compact fluid laundry detergent compositions, and the like and combinations thereof.
Transparent or translucent—As used herein, “translucent or transparent” refers to a transmittance of greater than about 25% transmittance of at least one wavelength of electromagnetic radiation in the visible spectrum (approx. 410-800 nm), more specifically a transmittance of more than about 25%, even more specifically more than about 30%, even more specifically still more than about 40%, yet even more specifically still more than about 50% in the visible part of the electromagnetic spectrum wherein % transmittance equals:

$$\frac{1}{{10}^{absorbancy}} \times 100 \% .$$

Alternatively, a container, composition and the like may be considered translucent or transparent if the absorbency of the bottle of the visible electromagnetic spectrum is less than about 0.6. An illustrative example of a translucent or transparent object would be a clear bottle or clear composition. Another example of a translucent or transparent object would be a bottle or composition which is colored, such having a blue or red tint, but still has a transmittance of greater than about 25% transmittance of at least one wavelength of electromagnetic radiation in the visible spectrum.

In one embodiment, the compact fluid laundry detergent composition is transparent or translucent and has a transmittance of at least about a 50% transmittance of light using a 1 cm cuvette at wavelengths of about 410 nanometers to about 800 nanometers.

Additional illustrative information and examples of translucent or transparent and opaque containers and/or compositions and the like can be found in U.S. Pat. Nos. 6,630,437 issued to Murphy et al; 6,756,350 issued to Giblin et al; 6,631,783 issued to Giblin et al; and 6,159,958 issued to Bae-Lee et al.

As used herein, “opaque” refers to a transmittance of less than about 25% transmittance of all wavelengths of electromagnetic radiation in the visible spectrum, more specifically a transmittance of less than about 20%, even more specifically less than about 15%, even more specifically still less than about 10%, yet even more specifically still less than about 5% in the visible part of the electromagnetic spectrum. Alternatively, a container, composition and the like may be considered opaque if the absorbency of the bottle of the visible electromagnetic spectrum is greater than about 0.6.

Use of the Composition—The compact fluid laundry detergent may be used as laundry cleaning products. In use, a measured amount of the compact fluid laundry detergent is deposited on the fabric, garment or the like or in the laundry washing machine, whereupon mixing with water, the cleaning of laundry is affected. It should be noted that the compact fluid laundry detergent are particularly suitable for the use in front-loading laundry machines, or so called High Efficiency, or HE washing machines.

In use suds Measurement—In one embodiment, a compact fluid laundry detergent may be shown to have a positive consumer value impression via an in use suds measurement. The procedure for performing an in use suds measurement is as follows.

The in use suds measurement is performed in a horizontal axis laundry washing machine available in the Western European market. The washing machine used for the procedure described here below is a Bosch Maxx WFL2450, manufactured by Bosch Siemens Household Appliances.

The same washing machine should be used for all tests. Before the test the washing machine should be cleaned from any detergent residues by running a full 95° C. wash cycle without detergent. A strip of tape graduated in centimeter is glued vertically to the window of the washing machine, in a way that the zero of the tape corresponds to the bottom of the window, and the top of the scale (26 cm) corresponds to the top of the window. The machine is filled with 3.2 kg of clean fabrics. The composition of the 3.2 kg wash load is as follows:

11 terry towels (70 cm×46 cm) (300 g/m²)

4×cotton fabrics (90 cm×70 cm) (188 g/m²)

4×polyester fabrics (90 cm×80 cm) (125 g/m2)

3×polycotton fabrics (90 cm×10 cm) (130 g/m²)

Before the first use, the fabrics described above are pre-conditioned in the following fashion:

a) Cotton and polycotton fabrics. A load of 3.0 kg is washed for 3 times using 105 grams of a Heavy Duty Granular detergent (for example Ariel Professional Powder Detergent from Procter and Gamble), using a horizontal axis Western European laundry washing machine (e.g. Bosch or Miele), using a 95° C. wash temperature, regular cotton cycle, 2.5 mmoles/liter water hardness, without drying in between the three washes. Following that the load is rewashed in the same machines, using a regular cotton wash cycle, 95° C., 2.5 mmoles/liter water hardness but without detergent, and it is tumble dried.
b) Polyester fabrics. A load of 3 kg of fabrics is washed 3 times with the same detergent and machine as above, using a short cycle, 60° C. washing temperature, 2.5 mmoles/liter water hardness, without drying in between the washes. Following that the load is rewashed in the same machines, using a short cycle, 60° C., 2.5 mmoles/liter water hardness but without detergent, and it is tumble dried.

The in-going wash water used hardness is adjusted to have a total hardness of 2.5 mmol/liter. The hardness is adjusted in the following way. If the local water has a lower hardness than 2.5 mmoles/liter, the hardness is adjusted by adding the required amount of a 36% solution of Calcium Chloride.

If the local water has a higher hardness than 2.5 mmoles/liter, the water is mixed with the required amount of a deionized water (obtained by reverse osmosis deionization system).

The hardness is measured using the following procedure. A sample of 50 mls of water is taken from the incoming water tap. Three drops of 25% ammonium hydroxide (e.g. a 25% solution of ammonium hydroxide, ex ACROS, New Jersey, USA, catalog #255 210025) are added. One tablet of indicator (Indikator-buffer tablet from Merck KGaA, Darmstadt, Germany, catalog #1.084301000) is added. The sample is titrated by adding a solution of Na2 EDTA (Triplex III solution, 0.01 mmol/liter, from Merck KGaA, Darmstadt, Germany, catalog #1.09992), until the color changes from red to green.

For the in use suds measurement the setting of the washing machine are the following ones: temperature is 40° C., cotton/linen cycle, spin rate 1000 RPM.

The composition to be tested is introduced in the machine using a dosing device (from Procter and Gamble), having the shape of sphere with a diameter of 70 mm, which is truncated at the top and at the bottom. The top part has a circular opening having a diameter of 45 mm. This dosing ball is put on a balance and filled with liquid detergent to the desired weight. The full doing ball is inserted in the washing machine, on top of the fabrics. The washing machine is then started.

The wash cycle consists in periodic rotation of the drum lasting for 20-30 seconds, followed by rest time of about 10 seconds. The suds heights are read every 4 minutes (plus or minus 30 seconds), during the rest time of the drum.

Sometimes a small layer of suds-free wash water is visible at the bottom of the drum, especially during rinse cycles. If this happens, the height if this water layer is present, is subtracted from the height of the suds layer.

The test is repeated four times using the same wash load and different aliquots of the detergent to be tested. Between each run the load is rewashed to eliminate any detergent residues. The rewash is run in the same machines, using a regular cotton wash cycel, 95° C., 2.5 mmoles/liter water hardness but without detergent, and following that the load is tumble dried. The final data are the result of the averaging of four washing machine runs.

The results of an in use suds measurement are summarized in table 1 here below for the product of the invention 1 and for reference compositions A and B. The product 1 is tested at its recommended dosage of 35 grams/wash. The comparative example product A is tested at its recommended dosage of 80.3 grams/wash, and also at an equal dosage to that of 1 (i.e. 35 grams/wash). The comparative example product B is tested at 35 grams as well.

TABLE 1

| | | Suds | | |
|---|---|---|---|---|
| | | height (cm) | | |
| | Inven- | Compar- | Compar- | Compar- |
| | tive | ative | ative | ative |
| | compo- | Compo- | Compo- | Compo- |
| | sition | sition | sition | sition |
| Product | 1 * | A | A | B |
| Dosage | 35 grams | 80.3 grams | 35 grams | 35 grams |
| (grams/wash) | | | | |
| Wash cycle | | | | |
| (minutes) | | | | |
| 4 | 0 | 0.1 | 0 | 0.5 |
| 8 | 0.9 | 0.7 | 0.5 | 1.6 |
| 12 | 1.5 | 0.7 | 0.5 | 1.4 |
| 16 | 1.9 | 1.7 | 0.5 | 1.5 |
| 20 | 3.5 | 2.6 | 0.5 | 1.7 |
| 24 | 7.9 | 3 | 1 | 1.7 |
| 28 | 11.2 | 3.5 | 1.2 | 2.1 |
| 32 | 13.3 | 5.7 | 1.2 | 2.7 |
| 36 | 14 | 6.7 | 1.4 | 3.2 |
| 40 | 15.2 | 9.5 | 1.5 | 3.6 |
| 44 | 15.7 | 10.5 | 2.2 | 3.4 |
| 48 | 16.1 | 9.5 | 2.1 | 2.9 |
| 52 | 16.5 | 11.5 | 2 | 3.5 |
| 56 | 17.1 | 12.5 | 1.9 | 3.5 |
| 60 | 17.6 | 12 | 2 | 3.2 |
| 64 | 18 | 12.5 | 2.1 | 4 |
| 68 | 18.6 | 12.5 | 2.4 | 4.5 |
| 72 | 19 | 13 | 2.4 | 4.1 |

* Average of two product production batches

The full composition of products 1, A and B is detailed in table 2

TABLE 2
(% by weight)

| | 1 | A | B |
|---|---|---|---|
| | Inven- | Compar- | Compar- |
| | tive | ative | ative |
| | Compo- | Compo- | Compo- |
| Ingredients | sition | sition | sition |
| Alkylbenzenesulfonic acid | 17.2 | 12.2 | 23 |
| C12-14 alcohol 7-ethoxylate | 8.5 | 0.4 | 19.5 |
| C14-15 alcohol 8-ethoxylate | | 9.6 | — |
| C12-14 alcohol 3-ethoxylate | 8.5 | | — |
| sulphate, Na salt | | | |
| C8-10 Alkylamidopropyldimethyl | — | — | 0.9 |
| amine | | | |
| Citric acid | 2.9 | 4.0 | — |
| C12-18 fatty acids | 12.7 | 4.0 | 17.3 |
| Protease ex Genencor (Protease | 2.4 | 0.72 | 1.3 |
| “B” in EP 251446, 40 mg | | | |
| protein/gram) | | | |
| Amylase (Natalase 200 L ex | 0.55 | 0.10 | 0.16 |
| Novozymes) | | | |
| Amylase (Termamyl 300 L ex | — | 0.07 | — |
| Novozymes) | | | |
| Mannanase 25 L (Novozymes) | 0.15 | 0.056 | 0.13 |
| Pectate lipase (Novozymes) | 0.40 | 0.17 | — |
| Lipase (Lipex ex Novozymes) | 0.25 | — | — |
| Ethoxylated polyimine | 1.4 | — | 1.6 |
| Ethoxylated polyimine polymer, | 3.7 | 1.8 | 1.6 |
| quaternized and sulphated | | | |
| Hydroxyethane diphosphonic | 1.4 | — | — |
| acids (HEDP) | | | |
| Pentamethylene triamine | — | 0.3 | — |
| pentaphosphonic acid | | | |
| Catechol 2, 5 disulfonate, | 0.9 | — | — |
| Na salt | | | |
| Fluorescent whitening agent | 0.3 | 0.1 | 0.3 |
| Solvent (1,2propandiol, | 3.5 | 6.2 | 22 |
| ethanol, diethyleneglycol) | | | |
| 1-ethoxypentanol | 0.9 | — | — |
| Monoethanolamine (MEA) | 10 | 0.8 | 8.0 |
| MEA borate | 0.5 | 2.4 | — |
| Water | 22.1 | 50.8 | 2.9 |
| Sodium hydroxide | — | 4.6 | — |
| Perfume, dyes, miscellaneous | balance | balance | balance |
| minors | | | |

Cleaning Assessment—The cleaning performance of the inventive composition of table 1 is tested. The following conditions are used:

Western European horizontal axis washing machine (Miele W918); regular program, short washing cycle, a water hardness of 2.5 mmoles/liter, a wash temperature of 40 C, a load of 1.5 kg of cotton items, including 15 different standard stains (make up, dirty motor oil, hamburger grease, bacon grease, curry, ragu, coffee, wine, gravy, chocolate ice cream, artificial menstrual fluid, grass, Brussels clay, Cincinnati clay, peat).

Inventive composition 1 is tested at a dosage of 35 grams/wash, and compared with the comparative liquid detergent composition A, which is tested at 80 grams/wash, under the same conditions and with the same stains.

At the end of the washes the stained washed with inventive composition 1 and those washed with comparative liquid detergent composition A are compared by a panel of 2 expert laundry graders, and the resulting stain removal (averaged across all stains) obtained with the two products is judged to be equal.

### EXAMPLES

Other compositions typical of the invention are exemplified in Tables 3& 4.

TABLE 3
(% by Weight)

| Ingredients | 2 | 3 |
|---|---|---|
| Alkylbenzenesulfonic acid | 22.5 | 20.0 |
| C12-14 alcohol 7-ethoxylate | 19.5 | 10.0 |
| C14-15 alcohol 8-ethoxylate | — | — |
| C12-14 alcohol 3-ethoxylate sulphate, Na salt | — | 10.0 |
| C10 alkyl N,N-di(2-hydroxyethyl) N-methyl | 2.0 | — |
| ammonium chloride | | |
| Citric acid | 4.0 | 1.5 |
| C12-18 fatty acids | 10.5 | 14.2 |
| Detergent enzymes | 3.1 | 4.0 |
| Polyethylenenimine mwt 600 Da, 20 Ethoxylate | 1.4 | 3.7 |
| Hexamethylene diamine 24 ethoxylate, dimethyl | 2.7 | — |
| quat, tetrasulfonate | | |
| Hydroxyethane diphosphonic acids (HEDP) | 2.0 | 1.4 |
| Catechol 2, 5 disulfonate, Na salt | — | 1.3 |
| Fluorescent whitening agent | 0.3 | 0.3 |
| 1,2 propandiol | 4.5 | 6.5 |
| Monoethanolamine (MEA) | 11.7 | 9.1 |
| MEA borate | — | 0.5 |
| Water | 11.5 | 15.0 |
| Sodium hydroxide | 0.1 | — |
| Hydrogenated castor oil | 0.2 | — |
| Perfume | 1.5 | 1.5 |

| | |
|---|---|
| Dyes, minors | Balance to 100% |

TABLE 4
(% by Weight)

| Ingredients | 4 | 5 | 6 |
|---|---|---|---|
| Alkylbenzenesulfonic acid | 23.5 | 11.5 | 19.5 |
| C12-14 alcohol 7-ethoxylate | 5.0 | 17.0 | 8.5 |
| C12-14 alcohol 3-ethoxylate sulphate, Na salt | 10.5 | 2.5 | 9.5 |
| C12 alkyl dimethylamine N-oxide | — | 2.0 | — |
| C8-10 Alkylamidopropyldimethyl amine | 0.5 | — | — |
| Citric acid | 1.5 | 4.0 | — |
| C12-18 fatty acids | 15.5 | 11 | 16 |
| Detergent enzymes | 3.1 | 4.0 | — |
| Polyethylenenimine mwt 600 Da, 20 Ethoxylate | — | 4.0 | 7.5 |
| Hexamethylene diamine 24 ethoxylate, dimethyl | 5.0 | — | — |
| quat, tetrasulfonate | | | |
| Hydroxyethane diphosphonic acids (HEDP) | 1.0 | — | 1.5 |
| Pentamethylene triamine pentaphosphonic acid | 0.5 | — | 1.0 |
| s,s-Ethylenediamine disuccinic acid | — | 3.0 | — |
| Catechol 2, 5 disulfonate, Na salt | — | 1.3 | 2.0 |
| Fluorescent whitening agent | 0.3 | 0.2 | — |
| Ethanol | 9.0 | 3.0 | — |
| propandiol | 3.5 | 6.0 | 11.0 |
| Glycerol | — | 5.5 | — |
| Monoethanolamine (MEA) | 9.5 | 10.0 | 9.0 |
| MEA borate | — | 0.5 | — |
| Water | 7.5 | 11.0 | 13.5 |
| Perfume | 1.5 | 2.5 | 0.5 |
| Potassium bisulfite | 0.15 | 0.10 | — |

| | |
|---|---|
| Dyes, minors | Balance to 100% |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

Except as otherwise noted, the articles “a,” “an,” and “the” mean “one or more.”

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. All temperatures are in degrees Celsius (° C.) unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A compact fluid laundry detergent composition having good economics, good cleaning and positive consumer value impression, comprising:
(i) at least about 10%, by weight of the composition, of surfactant selected from anionic surfactants, nonionic surfactants, soap and mixtures thereof;
(ii) from about 5% to about 30%, by weight of the composition, of water, non-aminofunctional solvent, or mixtures thereof;
(iii) from about 5% to about 20%, by weight of the composition, of a performance additive selected from chelants, soil suspending polymers, enzymes and mixtures thereof;
wherein said compact fluid laundry detergent composition comprises at least one of:
(A) said surfactant has a weight ratio of said anionic surfactant to said nonionic surfactant of at least 1.5:1, said anionic surfactant comprises from about 15% to about 40% by weight of the composition; and said soap comprises from about 5% to about 30%, by weight of the composition;
(B) from about 0.1% to about 10%, by weight of the composition, of a suds boosting agent selected from suds boosting polymers, cationic surfactants, zwitterionic surfactants, amine oxide surfactants, amphoteric surfactants, and mixtures thereof; and
(C) both (A) and (B).

2. The composition according to claim 1 wherein said compact fluid laundry detergent composition is substantially free of borax sorbitol pH jump systems.

3. The composition according to claim 1 wherein said surfactant are substantially linear.

4. The composition according to claim 1 wherein said anionic surfactant comprises from about 5% to about 40%, by weight of the composition, of alkylalkoxy sulfate surfactant.

5. The composition according to claim 1 wherein said compact fluid laundry detergent composition comprises (A) and said surfactant has a weight ratio of said anionic surfactant to said nonionic surfactant from about 2:1 to about 5:1, said surfactant comprises from about 15% to about 30%, by weight of the composition, of anionic surfactant and comprises from about 10% to about 40%, by weight of the composition, of said soap.

6. The composition according to claim 1 wherein said suds boosting polymers are selected from polymeric suds stabilizers, dialkyl acrylamides, block polymeric suds stabilizers, zwitterionic polymeric suds stabilizers, cationic polymeric suds stabilizers, anionic polymeric suds stabilizers and mixtures thereof.

7. The composition according to claim 1 wherein said chelants are selected from S,S-ethylenediamine disuccinic acid Catechol-2,5-disulfonate, ethylenediamine tetraacetic acid, Diethylenetriaminepentaacetate, 1-Hydroxyethylidene 1,1 diphosphonic acid, Diethylenetriamine-penta-methylene phosphonic acid, dipicolinic acid and mixtures thereof.

8. An article of commerce for laundering, storing and dispensing liquid compositions in contact therewith, comprising:
(a) a compact fluid laundry detergent composition having good economics, good cleaning and positive consumer value impression, comprising:
(i) at least about 10%, by weight of the composition, of surfactant selected from anionic surfactants, nonionic surfactants, soap and mixtures thereof;
(ii) from about 0.001% to about 3% by weight of the composition, of perfume;
(iii) from about 1% to about 30%, by weight of the composition, of water;
(iv) from about 1% to about 15%, by weight of the composition, of non-aminofunctional solvent; and
(v) from about 5% to about 20%, by weight of the composition, of a performance additive selected from chelants, soil suspending polymers, enzymes and mixtures thereof;
wherein said compact fluid laundry detergent composition comprises at least one of:
(A) said surfactant has a weight ratio of said anionic surfactant to said nonionic surfactant from about 1.5:1 to about 5:1, said surfactant comprises from about 15% to about 40%, by weight of the composition, of anionic surfactant and comprises from about 5 to about 40%, by weight of the composition, of said soap;
(B) from about 0.1% to about 10%, by weight of the composition, of a suds boosting agent selected from suds boosting polymers, cationic surfactants, zwitterionic surfactants, amine oxide surfactants, amphoteric surfactants, and mixtures thereof; and
(C) both (A) and (B); and
(b) a water insoluble container in direct contact with and releasably storing said compact fluid laundry detergent composition;

9. The article of commerce according to claim 8 wherein said water insoluble container is capable of preventing olfactory access by a consumer to a head space colocated with said compact fluid laundry detergent composition in said insoluble container during dispensing of said compact fluid laundry detergent.

10. Use of the article of commerce according to claim 8 for dispensing a variable dose of detergent and for laundering fabrics therewith.

11. Use of the article of commerce according to claim 8 for dispensing a premeasured dose of detergent and for laundering fabrics therewith.

12. Use of the article of commerce according to claim 8 in conjunction with a dispensing device for dispensing a variable dose of detergent and for laundering fabrics therewith.

13. Use of the article of commerce according to claim 8 in conjunction with a dispensing device for dispensing a variable dose of detergent and for laundering fabrics therewith, wherein said dispensing device is detachably mounted on said container.

14. A compact fluid laundry detergent composition having good economics, good cleaning and positive consumer value impression, comprising:
(i) from about 20% to about 80%, by weight of the composition, of surfactant selected from anionic surfactants, nonionic surfactants, soap and mixtures thereof;
(ii) from about 0.001% to about 3%, by weight of the composition, perfume;
(iii) from about 5% to about 30%, by weight of the composition, water;
(iv) from about 3% to about 10%, by weight of the composition, of non-aminofunctional solvent;
(v) from about 10% to about 20%, by weight of the composition, soap; and
(vi) from about 0% to about 1%, by weight of the composition, of hydrotropes and/or externally structuring thickeners;
(vii) from about 0% to about 5%, by weight of the composition, of amine oxide and/or betaine; and
(viii) from about 5% to about 20%, by weight of the composition, of a performance additive selected from chelants, soil suspending polymers, enzymes and mixtures thereof;
wherein said compact fluid laundry detergent composition comprises at least one of:
(A) said surfactant has a weight ratio of said anionic surfactant to said nonionic surfactant from about 1.5:1 to about 5:1, said surfactant comprises from about 15% to about 40%, by weight of the composition, of anionic surfactant and comprises from about 10% to about 20%, by weight of the composition, of said soap;
(B) from about 0.1% to about 10%, by weight of the composition, of a suds boosting agent selected from suds boosting polymers, cationic surfactants, zwitterionic surfactants, amine oxide surfactants, amphoteric surfactants, and mixtures thereof; and
(C) both (A) and (B).

15. The composition according to claim 14 wherein said compact fluid laundry detergent composition comprises an adjunct selected from clarifiers, pearlescents, opalescents, enzyme inhibitors, brighteners, builders, dye transfer inhibitors, dyes, bleach catalysts and/or bleach boosters, bleach activators, buffers, antimicrobial agents, UV absorbers, fabric softening additives, suds suppressors, dispersing agents, processing aids, structurants and mixtures thereof.

16. The composition according to claim 14 wherein said non-aminofunctional solvent is selected from C₁-C₅ alkanols, C₂-C₆ diols, C₃-C₈ alkylene glycols, C₃-C₈ alkylene glycol mono lower alkyl ethers, lower molecular weight polyethylene glycols and mixtures thereof.

17. An article of commerce for laundering, storing and dispensing liquid compositions in contact therewith, comprising:
(a) the compact fluid laundry detergent composition according to claim 1; and
(b) a water insoluble container in direct contact with and releasably storing said compact fluid laundry detergent composition;

18. The article of commerce according to claim 17 wherein said container is a bottom dispensing container comprising:
a deformable container for storing said compact fluid laundry detergent composition, said deformable container having a bottom end and an opening in said bottom end; and
a dispensing cap, removably attached to said bottom end of said deformable container and covering at least said opening in said bottom end.

19. A method of ensuring dose compliance on dosing a compact fluid laundry detergent composition, said method comprising providing the article of commerce according to claim 17 wherein said container or a dosing device for use therewith has markings to provide fractions of a recommended dose such that a specified numbers of fractions of the recommended dose are to be used for laundering in hard, medium and soft water.
